(19) United States
(12) Patent Application Publication
(10) Pub. No.: US 2016/0326273 A1
(43) Pub. Date: Nov. 10, 2016

(54) PHENOL-CONTAINING HYDROGENATED NITRILE RUBBERS

(71) Applicant: ARLANXEO DEUTSCHLAND GMBH, Dormagen (DE)

(72) Inventor: WERNER OBRECHT, MOERS (DE)

(21) Appl. No.: 15/108,972

(22) PCT Filed: Dec. 29, 2014
(86) PCT No.: PCT/EP2014/079368

§ 371 Date: Jun. 29, 2016

(30) Foreign Application Priority Data
Dec. 30, 2013 (EP) 13199837.9

(51) Int. Cl. C08C 19/02; C08J 3/24; C08C 2/02

(52) U.S. Cl. CPC C08C 19/02; C08C 2/02; C08J 3/24; C08J 2315/00

(57) ABSTRACT

Novel hydrogenated nitrile rubbers having a specific phenol content are provided, as are a process for production thereof, vulcanizable mixtures based thereon and vulcanizates thus obtained. The vulcanizates feature particularly good moduli and compression set values.

The invention relates to specific phenol-containing hydrogenated nitrile rubbers, to a process for production thereof, to vulcanizable mixtures based thereon and to vulcanizates obtained in this way.

Nitrile rubbers are co- and terpolymers of at least one unsaturated nitrile monomer, at least one conjugated diene and optionally one or more further copolymerizable monomers. Processes for producing nitrile rubber (Ullmann's Encyclopedia of Industrial Chemistry, VCH Verlagsgesellschaft, Weinheim, 1993, p. 255-261) and processes for hydrogenating nitrile rubber in suitable organic solvents are known (Ullmann's Encyclopedia of Industrial Chemistry, VCH Verlagsgesellschaft, Weinheim, 1993, p. 320-324).

Hydrogenated nitrile rubber, also abbreviated to “HNBR”, is understood to mean rubbers which are obtained using nitrile rubbers, also abbreviated to “NBR”, by hydrogenation. Correspondingly, in HNBR, the C═C double bonds of the copolymerized diene units are fully or partly hydrogenated. The hydrogenation level of the copolymerized diene units is typically within a range from 50 to 100%. However, those skilled in the art refer to “fully hydrogenated types” even when the residual double bond content is not more than about 0.9%. The HNBR types commercially available on the market typically have a Mooney viscosity (ML 1+4 at 100° C.) in the range from 10 to 120 Mooney units.

HNBR is a specialty rubber having a very good heat resistance, excellent resistance to ozone and chemicals and excellent oil resistance. The aforementioned physical and chemical properties of HNBR are combined with very good mechanical properties, especially a high abrasion resistance. Because of this profile of properties, HNBR has found wide use in a wide variety of different areas of application. HNBR is used, for example, for seals, hoses, drive belts, cable sheaths, roller coverings and damping elements in the automotive sector, and also for stators, well seals and valve seals in the oil production sector, and also for numerous parts in the aviation industry, the electrical industry, in mechanical engineering and in shipbuilding.

A major role is played by vulcanizates of HNBR having a high modulus level and low compression set, especially after long storage periods at high temperatures. This combination of properties is important for fields of use in which high resilience forces are required to ensure that the rubber articles will function both under static and dynamic stress, especially after long periods and possibly high temperatures. This applies particularly to different seals such as O-rings, flange seals, shaft sealing rings, stators in rotor/stator pumps, valve shaft seals, gasket sleeves such as axle boots, hose seals, engine bearings, bridge bearings and well seals (blowout preventers). In addition, vulcanizates having a high modulus are important for articles under dynamic stress, especially for belts such as drive belts and control belts, especially toothed belts, and for roller coverings.

It is not just the optimization of the properties of the hydrogenated nitrile rubber and of vulcanizates based thereon that is of high significance; the process for producing hydrogenated nitrile rubbers with optimization of the process conditions is also the subject of continuous research and development activities.

U.S. Pat. No. 4,503,196 describes a process for hydrogenating nitrile rubber using rhodium catalysts of the (H)Rh(L)₃ or (H)Rh(L)₄ type. L is a phosphine- or arsine-containing ligand. The hydrogenation is conducted with relatively high amounts of catalyst (2.5 to 40% by weight) without additions of the ligands. For the isolation of the hydrogenated nitrile rubber from the chlorobenzene solution, the hydrogenated solution is cooled and the rubber is coagulated by addition of isopropanol. No details are given as to the vulcanizate properties of the hydrogenated nitrile rubbers that are the result of this process. Thus, it is not possible to infer any teaching as to the optimization of the hydrogenation process of nitrile rubber from U.S. Pat. No. 4,503,196, nor are there any pointers as to the optimization of the moduli and compression set values of vulcanizates based on HNBR.

DE-A-3 921 264 describes the production of hydrogenated nitrile rubber which, after peroxidic crosslinking, gives vulcanizates having low compression set. In the hydrogenation, ruthenium catalysts of very different chemical constitution are used, with use of a solvent mixture of a C₃-C₆ ketone and a secondary or tertiary C₃-C₆ alcohol. The proportion of the secondary or tertiary alcohol in the solvent mixture is said to be 2 to 60% by weight. It is stated that, during the hydrogenation or in the course of cooling of the solution after hydrogenation, two phases may be formed. As a consequence, the desired hydrogenation levels are not attained and/or hydrogenated nitrile rubber gelates during the hydrogenation. The process described in DE-A-3 921 264 is not broadly applicable, since the phase separation which takes place in the course of hydrogenation and the gelation depends on a number of parameters in an unpredictable manner. These include the acrylonitrile content and the molar mass of the nitrile rubber feedstock, the composition of the solvent mixture, the solids content of the polymer solution in the hydrogenation, the hydrogenation level and the temperature in the hydrogenation. In the course of cooling of the polymer solution after the hydrogenation or in the course of storage of the polymer solution too, there may be unwanted phase separation and contamination of the corresponding plant components or vessels. DE-A-3 921 264 does not give any teaching relating to improvement of the modulus level and of the compression set via the production of the nitrile rubber feedstock and no further optimization proposals are made regarding the hydrogenation process either.

EP-A-0 134 023 describes a process for hydrogenating NBR with small amounts of tris(triphenylphosphine)rhodium(I) halide, preferably 0.08 to 0.2% by weight, not more than 2% by weight of triphenylphosphine, within selected pressure (preferably 30 to 350 bar) and temperature ranges (100° C. to 145° C.). The examples in Table 3 show that an increase in the amount of triphenylphosphine from 0 to 5% by weight leads to a deterioration in important properties of peroxidically vulcanized hydrogenated nitrile rubbers. For instance, there is a decrease in the modulus values at 100%, 200% and 300% elongation, and in the hardness at 23° C. There is an increase in the elongation at break and compression set values after aging at 23° C. for 70 h, at 125° C. for 70 h and at 150° C. for 70 h. In order to limit the harmful influence of triphenylphosphine, according to the teaching of EP-A-0134 023, the amount of triphenylphosphine used in the hydrogenation is restricted to <0.6% by weight. A disadvantage in a hydrogenation in the presence of amounts of triphenylphosphine of <0.6% by weight is that it is necessary to use higher amounts of costly rhodium metal for the achievement of unchanged hydrogenation times, or that very much longer hydrogenation times have to be accepted with unchanged amounts of catalyst. EP-A-0 134 023 gives neither any teaching as to the reduction in the hydrogenation times without increasing the amounts of triphenylphosphine, nor as to the reduction of the hydrogenation times without adverse effects on the modulus and compression set levels of the vulcanizates of the hydrogenated nitrile rubbers that are the result here.

EP 2 238 177 A describes the production of nitrile rubber having high storage stability, by conducting the latex coagulation with alkaline earth metal salts in combination with gelatin. The nitrile rubbers have an exceptional ion index with regard to the contents of sodium, potassium, magnesium and calcium ions present in the nitrile rubber. In the general part of EP 2 238 177 A, some ageing stabilizers that are added to the nitrile rubber latex prior to coagulation are enumerated, although no amounts are stated. It is apparent from the examples that 2,2-methylenebis(4-methyl-6-tert-butylphenol) was used, the amount of which varied within a range from 0.1 to 0.8% by weight based on rubber solids. It is shown that the storage stability of the nitrile rubber does not depend on the amount of 2,2-methylenebis(4-methyl-6-tert-butylphenol) and, even when the smallest amount (0.1% by weight) of 2,2-methylenebis(4-methyl-6-tert-butylphenol) is used, adequate storage stabilities are achieved. It can be concluded from this that the amount of 2,2-methylenebis(4-methyl-6-tert-butylphenol) has only a minor influence (if any) on the properties of the nitrile rubber. No further conclusions are possible with regard to the influence of 2,2-methylenebis(4-methyl-6-tert-butylphenol) on the properties of hydrogenated nitrile rubber which is obtained by hydrogenation proceeding from nitrile rubbers of this kind.

### Problem Addressed by the Present Invention

The problem addressed by the present invention was thus that of providing a hydrogenation process for nitrile rubbers in the presence of activity-enhancing additions which can remain in the hydrogenated nitrile rubber after the hydrogenation, but without having any adverse effects on the vulcanizate properties thereafter. A further problem addressed by the present invention was to make it possible to obtain hydrogenated nitrile rubbers having very good vulcanizate properties.

### Solution

This problem was surprisingly solved by conducting the hydrogenation of nitrite rubbers in the presence of specific phenols. These may either already be present in the nitric rubber which is used as a feedstock for the hydrogenation, or else may be added to the reaction system only in the course of the hydrogenation. These specific phenols show an unexpected accelerating influence on the hydrogenation and can remain in the hydrogenated nitrile rubber without this leading to any adverse effects on the properties of vulcanizates based on hydrogenated nitrile rubbers produced in this way.

The present invention thus provides a process for producing hydrogenated nitrile rubbers by hydrogenation of nitrile rubbers in solution, characterized in that the hydrogenation is effected in the presence of at least one phenol of the general formula (I),

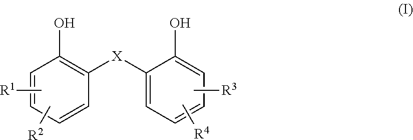

in which
X is sulphur, a divalent, straight-chain or branched, acyclic or cyclic hydrocarbyl group, preferably a divalent C₁-C₈ alkylene radical, more preferably methylene, ethylene or n-propylene, or a radical of the formula (II) in which n=0 to 9

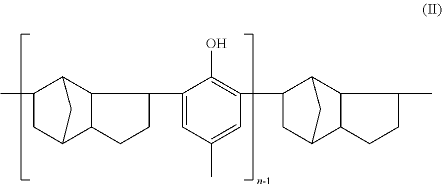

R¹, R², R³ and R⁴ are the same or different and are each straight-chain or branched, unsubstituted or substituted C₁-C₈ alkyl groups, preferably straight-chain or branched, unsubstituted or substituted C₁-C₆ alkyl groups,
   where the phenol of the general formula (I) is present in an amount of 0.01 to 0.25% by weight, preferably 0.05 to 0.2% by weight, more preferably 0.05 to 0.19% by weight, and most preferably 0.05 to 0.18% by weight, based on the nitrile rubber used.

The present invention further provides hydrogenated nitrile rubbers containing at least one phenol of the general formula (I)

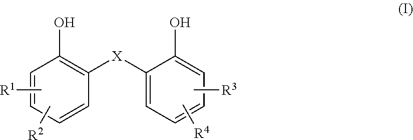

in which
X is sulphur, a divalent, straight-chain or branched, acyclic or cyclic hydrocarbyl group, preferably a divalent C₁-C₈ alkylene radical, more preferably methylene, ethylene or n-propylene, or a radical of the formula (II) in which n=0 to 9

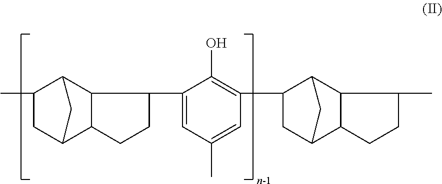

R¹, R², R³ and R⁴ are the same or different and are each straight-chain or branched, unsubstituted or substituted C₁-C₈ alkyl groups, preferably straight-chain or branched, unsubstituted or substituted C₁-C₆ alkyl groups,
   in an amount in the range from 0.01 to 0.25% by weight, preferably 0.05 to 0.2% by weight, more preferably 0.05 to 0.19% by weight, and most preferably 0.05 to 0.18% by weight, based on the hydrogenated nitrile rubber.

The present invention further provides vulcanizable mixtures of these hydrogenated nitrile rubbers, processes for producing vulcanizates based thereon, and also the vulcanizates obtainable therefrom, especially in the form of shaped bodies.

### Inventive Hydrogenated Nitrile Rubbers:

The inventive hydrogenated nitric rubbers contain at least one phenol of the general formula (I) in an amount in the range from 0.01 to 0.25% by weight, preferably 0.05 to 0.2% by weight, more preferably 0.05 to 0.19% by weight and most preferably 0.05 to 0.18% by weight, based on the hydrogenated nitrile rubber.

In an alternative embodiment the inventive hydrogenated nitrile rubbers contain at least one phenol of the general formula (I) in an amount in the range from 0.01 to 0.19% by weight, and preferably 0.01 to 0.18% by weight based on the hydrogenated nitrile rubber.

The inventive hydrogenated nitrile rubbers which, as phenol of the general formula (I), a compound selected from the group consisting of 2,2-methylenebis(4-methyl-6-tert-butylphenol), 2,2-thiobis(6-tert-butyl-p-cresol) and a butylated reaction product of p-cresol and dicyclopentadiene.

2,2-Methylenebis(4-methyl-6-tert-butylphenol) of the formula

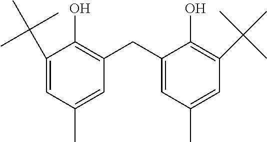 [SMILES: Cc1cc(Cc2cc(C)cc(C(C)(C)C)c2O)c(O)c(C(C)(C)C)c1]

is commercially available, for example, in the form of Vulkanox® BKF from Lanxess Deutschland GmbH.

2,2-Thiobis(6-tert-butyl-p-cresol) of the formula

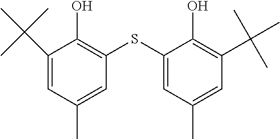 [SMILES: Cc1cc(Sc2cc(C)cc(C(C)(C)C)c2O)c(O)c(C(C)(C)C)c1]

is commercially available, for example, in the form of, for example, Lowinox® TBP-6 from Chemtura.

The butylated reaction product of p-cresol and dicyclopentadiene of the formula

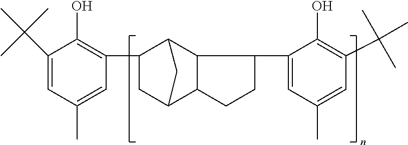

n=1 bis n=10
CAS-Nr.: 68610-51-5
   is commercially available, for example, in the form of Wingstay® L from Eliokem.

### Repeating Units of the Hydrogenated Nitrile Rubber:

The inventive hydrogenated nitrile rubbers have repeating units of at least one α,β-unsaturated nitrile monomer and at least one conjugated diene monomer. They may additionally have repeating units of one or more further copolymerizable monomers.

The inventive hydrogenated nitrile rubbers comprise fully or partly hydrogenated nitrile rubbers. The hydrogenation level is typically within a range from 50 to 100%, preferably within the range from 75 to 100%, more preferably within the range from 80 to 100%, even more preferably within the range from 90 to 100%, especially within the range from greater 94.5 to 100% and especially preferred within the range from 95% to 100%. Those skilled in the art refer to “fully hydrogenated types” even when the residual double bond content (also abbreviated to “RDB”) is not more than about 0.9%, meaning that the hydrogenation level is greater than or equal to 99.1%.

In one embodiment of the invention the inventive hydrogenated nitrile rubbers possess a hydrogenation level within the range from 95 to 100%, preferably within the range from 96% to 100% or more preferably represent fully hydrogenated types with at a hydrogenation degree of greater than or equal to 99.1% and contain at least one phenol of general formula (I) in an amount within the range from 0.01 to 0.19% by weight, preferably within the range from 0.01 to 0.18% by weight and most preferably within the range from 0.05 to 0.18% by weight, based on the hydrogenated nitrile rubber.

The repeating units of the at least one conjugated diene are preferably based on (C₄-C₆) conjugated dienes or mixtures thereof. Particular preference is given to 1,2-butadiene, 1,3-butadiene, isoprene, 2,3-dimethylbutadiene, piperylene and mixtures thereof. Especially preferred are 1,3-butadiene, isoprene and mixtures thereof. Even more preferred is 1,3-butadiene.

The α,β-unsaturated nitrile used for production of the inventive nitrile rubbers may be any known α,β-unsaturated nitrile, preference being given to (C₃-C₅)-α,β-unsaturated nitriles such as acrylonitrile, methacrylonitrile, ethacrylonitrile or mixtures thereof. Particular preference is given to acrylonitrile.

If one or more further copolymerizable monomers are used, these may, for example, be aromatic vinyl monomers, preferably styrene, α-methylstyrene and vinylpyridine, fluorinated vinyl monomers, preferably fluoroethyl vinyl ether, fluoropropyl vinyl ether, o-fluoromethylstyrene, vinyl pentafluorobenzoate, difluoroethylene and tetrafluoroethylene, or else copolymerizable antiageing monomers, preferably N-(4-anilinophenyl)acrylamide, N-(4-anilinophenyl)methacrylamide, N-(4-anilinophenyl)cinnamide, N-(4-anilinophenyl)crotonamide, N-phenyl-4-(3-vinylbenzyloxy)aniline and N-phenyl-4-(4-vinylbenzyloxy)aniline, and also nonoconjugated dienes, such as 4-cyanocyclohexene and 4-vinylcyclohexene, or else alkynes such as 1- or 2-butyne.

In addition, the copolymerizable termonomers used may be monomers containing hydroxyl groups, preferably hydroxyalkyl (meth)acrylates. It is also possible to use correspondingly substituted (meth)acrylamides.

Examples of suitable hydroxyalkyl acrylate monomers are 2-hydroxyethyl (meth)acrylate, 2-hydroxypropyl (meth)acrylate, 3-hydroxypropyl (meth)acrylate, 3-chloro-2-hydroxypropyl (meth)acrylate, 3-phenoxy-2-hydroxypropyl (meth)acrylate, glyceryl mono(meth)acrylate, hydroxybutyl (meth)acrylate, 3-chloro-2-hydroxypropyl (meth)acrylate, hydroxyhexyl (meth)acrylate, hydroxyoctyl (meth)acrylate, hydroxymethyl(meth)acrylamide, 2-hydroxypropyl (meth)acrylate, 3-hydroxypropyl(meth)acrylamide, di(ethylene glycol) itaconate, di(propylene glycol) itaconate, bis(2-hydroxypropyl) itaconate, bis(2-hydroxyethyl) itaconate, bis(2-hydroxyethyl) fumarate, bis(2-hydroxyethyl) maleate and hydroxymethyl vinyl ketone.

In addition, the copolymerizable termonomers used may be monomers containing epoxy groups, preferably glycidyl (meth)acrylates.

Preferred examples of monomers containing epoxy groups are diglycidyl itaconate, glycidyl p-styrenecarboxylate, 2-ethylglycidyl acrylate, 2-ethylglycidyl methacrylate, 2-(n-propyl)glycidyl acrylate, 2-(n-propyl)glycidyl methacrylate, 2-(n-butyl)glycidyl acrylate, 2-(n-butyl)glycidyl methacrylate, glycidyl methacrylate, glycidylmethyl methacrylate, glycidyl acrylate, (3′,4′-epoxyheptyl)-2-ethyl acrylate, (3′,4′-epoxyheptyl)-2-ethyl methacrylate, 6′,7′-epoxyheptyl acrylate, 6′,7′-epoxyheptyl methacrylate, allyl glycidyl ether, allyl 3,4-epoxyheptyl ether, 6,7-epoxyheptyl allyl ether, vinyl glycidyl ether, vinyl 3,4-epoxyheptyl ether, 3,4-epoxyheptyl vinyl ether, 6,7-epoxyheptyl vinyl ether, o-vinylbenzyl glycidyl ether, m-vinylbenzyl glycidyl ether, p-vinylbenzyl glycidyl ether and 3-vinylcyclohexene oxide.

Alternatively, further copolymerizable monomers used may be copolymerizable termonomers containing carboxyl groups, for example α,β-unsaturated monocarboxylic acids, esters thereof, α,β-unsaturated dicarboxylic acids, mono- or diesters thereof or the corresponding anhydrides or amides thereof.

The α,β-unsaturated monocarboxylic acids used may preferably be acrylic acid and methacrylic acid.

It is also possible to use esters of the α,β-unsaturated monocarboxylic adds, preferably the alkyl esters and alkoxyalkyl esters thereof. Preference is given to the alkyl esters, especially C₁-C₁₈ alkyl esters, of the α,β-unsaturated monocarboxylic acids, particular preference to alkyl esters, especially C₁-C₁₈ alkyl esters of acrylic acid or of methacrylic acid, especially methyl acrylate, ethyl acrylate, propyl acrylate, n-butyl acrylate, tert-butyl acrylate, 2-ethylhexyl acrylate, n-dodecyl acrylate, methyl methacrylate, ethyl methacrylate, butyl methacrylate and 2-ethylhexyl methacrylate. Preference is also given to alkoxyalkyl esters of the α,β-unsaturated monocarboxylic acids, particular preference to alkoxyalkyl esters of acrylic acid or of methacrylic acid, especially C₂-C₁₂-alkoxyalkyl esters of acrylic acid or of methacrylic acid, even more preferably methoxymethyl acrylate, ethoxyethyl (meth)acrylate and methoxyethyl (meth)acrylate. It is also possible to use mixtures of alkyl esters, for example those mentioned above, with alkoxyalkyl esters, for example in the form of those mentioned above. It is also possible to use cyanoalkyl acrylates and cyanoalkyl methacrylates in which the number of carbon atoms in the cyanoalkyl group is 2-12, preferably α-cyanoethyl acrylate, β-cyanoethyl acrylate and cyanobutyl methacrylate. It is also possible to use hydroxyalkyl acrylates and hydroxyalkyl methacrylates in which the number of carbon atoms of the hydroxyalkyl groups is 1-12, preferably 2-hydroxyethyl acrylate, 2-hydroxyethyl methacrylate and 3-hydroxypropyl acrylate; it is also possible to use acrylates or methacrylates containing fluorine-substituted benzyl groups, preferably fluorobenzyl acrylate and fluorobenzyl methacrylate. It is also possible to use acrylates and methacrylates containing fluoroalkyl groups, preferably trifluoroethyl acrylate and tetrafluoropropyl methacrylate. It is also possible to use α,β-unsaturated carboxylic esters containing amino groups, such as dimethylaminomethyl acrylate and diethylaminoethyl acrylate.

Further monomers used may be α,β-unsaturated dicarboxylic acids, preferably maleic acid, fumaric acid, crotonic acid, itaconic acid, citraconic acid and mesaconic acid.

It is additionally possible to use α,β-unsaturated dicarboxylic anhydrides, preferably maleic anhydride, itaconic anhydride, citraconic anhydride and mesaconic anhydride.

It is additionally possible to use mono- or diesters of α,β-unsaturated dicarboxylic acids.

These α,β-unsaturated dicarboxylic mono- or diesters may, for example, be alkyl, preferably C₁-C₁₀-alkyl, especially ethyl, n-propyl, isopropyl, n-butyl, tert-butyl, n-pentyl or n-hexyl, alkoxyalkyl, preferably C₂-C₁₂-alkoxyalkyl, more preferably C₃-C₈-alkoxyalkyl, hydroxyalkyl, preferably C₁-C₁₂-hydroxyalkyl, more preferably C₂-C₈-hydroxyalkyl, cycloalkyl, preferably C₅-C₁₂-cycloalkyl, more preferably C₆-C₁₂-cycloalkyl, alkylcycloalkyl, preferably C₆-C₁₂-alkylcycloalkyl, more preferably C₇-C₁₀-alkylcycloalkyl, aryl, preferably C₆-C₁₄-aryl, mono- or diesters, where any diesters may also be mixed esters.

Particularly preferred alkyl esters of α,μ-unsaturated monocarboxylic acids are methyl (meth)acrylate, ethyl (meth)acrylate, propyl (meth)acrylate, n-butyl (meth)acrylate, t-butyl (meth)acrylate, hexyl (meth)acrylate, 2-ethylhexyl (meth)acrylate, octyl (meth)acrylate, 2-propylheptyl acrylate and lauryl (meth)acrylate. In particular, n-butyl acrylate is used.

Particularly preferred alkoxyalkyl esters of the α,β-unsaturated monocarboxylic acids are methoxyethyl (meth)acrylate, ethoxyethyl (meth)acrylate and methoxyethyl (meth)acrylate. In particular, methoxyethyl acrylate is used.

Other esters of the α,β-unsaturated monocarboxylic acids used are additionally, for example, polyethylene glycol (meth)acrylate, polypropylene glycol (meth)acrylate, N-(2-hydroxyethyl)acrylamide, N-(2-hydroxymethyl)acrylamide and urethane (meth)acrylate.

Examples of α,β-unsaturated dicarboxylic monoesters include
monoalkyl maleates, preferably monomethyl maleate, monoethyl maleate, monopropyl maleate and mono-n-butyl maleate;
monocycloalkyl maleates, preferably monocyclopentyl maleate, monocyclohexyl maleate and monocycloheptyl maleate;
monoalkylcycloalkyl maleates, preferably monomethylcyclopentyl maleate and monoethylcyclohexyl maleate;
monoaryl maleates, preferably monophenyl maleate;
monobenzyl maleates, preferably monobenzyl maleate;
monoalkyl fumarates, preferably monomethyl fumarate, monoethyl fumarate, monopropyl fumarate and mono-n-butyl fumarate;
monocycloalkyl fumarates, preferably monocyclopentyl fumarate, monocyclohexyl fumarate and monocycloheptyl fumarate;
monoalkylcycloalkyl fumarates, preferably monomethylcyclopentyl fumarate and monoethylcyclohexyl fumarate;
monoaryl fumarates, preferably monophenyl fumarate;
monobenzyl fumarates, preferably monobenzyl fumarate;
monoalkyl citraconates, preferably monomethyl citraconate, monoethyl citraconate, monopropyl citraconate and mono-n-butyl citraconate;
monocycloalkyl citraconates, preferably monocyclopentyl citraconate, monocyclohexyl citraconate and monocycloheptyl citraconate;
monoalkylcycloalkyl citraconates, preferably monomethylcyclopentyl citraconate and monoethylcyclohexyl citraconate;
monoaryl citraconates, preferably monophenyl citraconate;
monobenzyl citraconates, preferably monobenzyl citraconate;
monoalkyl itaconates, preferably monomethyl itaconate, monoethyl itaconate, monopropyl itaconate and mono-n-butyl itaconate;
monocycloalkyl itaconates, preferably monocyclopentyl itaconate, monocyclohexyl itaconate and monocycloheptyl itaconate;
monoalkylcycloalkyl itaconates, preferably monomethylcyclopentyl itaconate and monoethylcyclohexyl itaconate;
monoaryl itaconates, preferably monophenyl itaconate;
monobenzyl itaconates, preferably monobenzyl itaconate;
monoalkyl mesaconates, preferably monoethyl mesaconate.

The α,β-unsaturated dicarboxylic diesters used may be the analogous diesters based on the aforementioned monoester groups, where the ester groups may also be chemically different groups.

Useful further copolymerizable monomers are additionally free-radically polymerizable compounds containing at least two olefinic double bonds per molecule. Examples of polyunsaturated compounds are acrylates, methacrylates or itaconates of polyols, for example ethylene glycol diacrylate, diethylene glycol dimethacrylate, triethylene glycol diacrylate, butanediol 1,4-diacrylate, propane-1,2-diol diacrylate, butane-1,3-diol dimethacrylate, neopentyl glycol diacrylate, trimethylolpropane di(meth)acrylate, trimethylolethane di(meth)acrylate, glyceryl di- and triacrylate, pentaerythrityl di-, tri- and tetraacrylate or -methacrylate, dipentaerythrityl tetra-, penta- and hexaacrylate or -methacrylate or -itaconate, sorbityl tetraacrylate, sorbityl hexamethacrylate, diacrylates or dimethacrylates of 1,4-cyclohexanediol, 1,4-dimethylolcyclohexane, 2,2-bis(4-hydroxyphenyl)propane, of polyethylene glycols or of oligoesters or oligourethanes with terminal hydroxyl groups. The polyunsaturated monomers used may also be acrylamides, for example methylenebisacrylamide, hexamethylene-1,6-bisacrylamide, diethylenetriaminetrismethacrylamide, bis(methacrylamidopropoxy)ethane or 2-acrylamidoethyl acrylate. Examples of polyunsaturated vinyl and allyl compounds are divinylbenzene, ethylene glycol divinyl ether, diallyl phthalate, allyl methacrylate, diallyl maleate, triallyl isocyanurate or triallyl phosphate.

The proportions of conjugated diene and α,β-unsaturated nitrile in the nitrile rubbers for use in the process according to the invention or the inventive hydrogenated nitrile rubbers may vary within wide ranges. The proportion of, or the sum total of, the conjugated diene(s) is typically in the range from 20 to 95% by weight, preferably in the range from 45 to 90% by weight, more preferably in the range from 50 to 85% by weight, based on the overall polymer. The proportion of, or the sum total of, the α,β-unsaturated nitrile(s) is typically in the range from 5 to 80% by weight, preferably 10 to 55% by weight, more preferably 15 to 50% by weight, based on the overall polymer. The proportions of the repeating units of conjugated diene and α,β-unsaturated nitrite in the inventive nitrile rubbers or the inventive fully or partly hydrogenated nitrite rubbers add up to 100% by weight in each case.

The additional monomers may be present in amounts of 0 to 40% by weight, preferably 0 to 30% by weight, more preferably 0 to 26% by weight, based on the overall polymer. In this case, corresponding proportions of the repeating units of the conjugated diene(s) and/or of the repeating units of the α,β-unsaturated nitrile(s) are replaced by the proportions of these additional monomers, where the proportions of the repeating units of all the monomers must add up to 100% by weight in each case.

If esters of (meth)acrylic acid are used as additional monomers, this is typically done in amounts of 1 to 25% by weight. If α,β-unsaturated mono- or dicarboxylic acids are used as additional monomers, this is typically done in amounts of less than 10% by weight.

Preference is given to inventive nitrile rubbers having repeating units of acrylonitrile, and 1,3-butadiene. Preference is further given to nitrite rubbers having repeating units of acrylonitrile, 1,3-butadiene and one or more further copolymerizable monomers. Preference is likewise given to nitrile rubbers having repeating units of acrylonitrile, 1,3-butadiene and one or more α,β-unsaturated mono- or dicarboxylic acids or esters or amides thereof, and especially repeating units of an alkyl ester of an α,β-unsaturated carboxylic acid, most preferably of methyl (meth)acrylate, ethyl (meth)acrylate, propyl (meth)acrylate, n-butyl (meth)acrylate, t-butyl (meth)acrylate, hexyl (meth)acrylate, 2-ethylhexyl (meth)acrylate, octyl (meth)acrylate or lauryl (meth)acrylate.

The nitrogen content is determined in the inventive hydrogenated nitrile rubbers to DIN 53 625 according to Kjeldahl. Due to the content of polar comonomers, the nitrite rubbers are typically ≧85% by weight soluble in methyl ethyl ketone at 20° C.

In one embodiment of the invention the inventive hydrogenated nitrite rubbers represent copolymers having repeating units exclusively derived from acrylonitrile and butadiene, and contain at least one phenol of general formula (I) in an amount within the range from 0.01 to 0.19% by weight, preferably within the range from 0.01 to 0.18% by weight and most preferably within the range from 0.05 to 0.18% by weight, based on the hydrogenated nitrile rubber. Typically such hydrogenated acrylonitrile-butadiene copolymers have a hydrogenation degree in the range from 90 to 100%, preferably 92 to 100%, more preferably 95 to 100%.

The inventive hydrogenated nitrile rubbers have Mooney viscosities ML 1+4 at 100° C. of 10 to 150 Mooney units (MU), preferably of 20 to 100 MU.

The glass transition temperatures of the inventive nitrile rubbers or the inventive fully or partly hydrogenated nitrile rubbers are within the range of −70° C. to +10° C., preferably within the range of −60° C. to 0° C.

### Process for Producing the Inventive Hydrogenated Nitrile Rubbers:

According to the invention, the hydrogenated nitrile rubbers are prepared by hydrogenation of nitrile rubbers in solution in the presence of at least one phenol of the general formula (I), where the phenol of the general formula (I) is present in an amount of 0.01 to 0.25% by weight, preferably 0.05 to 0.2% by weight, more preferably 0.05 to 0.19% by weight, and most preferably 0.05 to 0.18% by weight based in each case on the hydrogenated nitrile rubber used.

In one embodiment, a nitrile rubber which already contains the amount of the at least one phenol of the general formula (I) mentioned is used here. The nitrile rubbers are typically produced via emulsion polymerization with formation of a nitrile rubber latex and a subsequent coagulation of the nitrile rubber. This is sufficiently well known to the person skilled in the art. Preferably, the latex coagulation of the nitrile rubber is effected by the process described in general terms in EP-A-1 369 436. The at least one phenol of the general formula (I) can, for example, typically be added to the nitrile rubber latex formed after the emulsion polymerization, prior to coagulation. It has been found to be useful to add the phenol of the general formula (I) as an aqueous dispersion. The concentration of this aqueous dispersion is typically within a range from 2.50-70% by weight, preferably 5-60% by weight.

In an alternative embodiment, the phenol of the general formula (I) is only added separately in the reaction mixture of the hydrogenation.

### Hydrogenation:

The hydrogenation is typically conducted in the presence of at least one hydrogenation catalyst typically based on the noble metals rhodium, ruthenium, osmium, palladium, platinum or iridium, preference being given to rhodium, ruthenium and osmium.

It is possible to use rhodium complex catalysts of the general formula (A)

Rh(X)ₙ(L)ₘ (A)

where
X is the same or different and is hydrogen, halogen, pseudohalogen, SnCl₃ or carboxylate,
n is 1, 2 or 3, preferably 1 or 3,
L is the same or different and represents mono- or bidentate ligands based on phosphorus, arsenic or antimony,
m is 2, 3 or 4 if L represents monodentate ligands, or is 1 or 1.5 or 2 or 3 or 4 if L represents bidentate ligands.

In the general formula (A), X is the same or different and is preferably hydrogen or chlorine.

L in the general formula (A) is preferably a phosphine or diphosphine corresponding to the general formulae (1-a) and (1-b) shown above, including the general, preferred and particularly preferred definitions given there.

Particularly preferred catalysts of the general formula (A) are tris(triphenylphosphine)rhodium(I) chloride, tris(triphenylphosphine)rhodium(III) chloride, tris(dimethyl sulphoxide)rhodium(III) chloride, hydridorhodiumtetrakis(triphenylphosphine) and the corresponding compounds in which triphenylphosphine has been replaced wholly or partly by tricyclohexylphosphine.

It is also possible to use ruthenium complex catalysts. These are described, for example, in DE-A 39 21 264 and EP-A-0 298 386. They typically have the general formula (B)

RuXₙ[(L¹)ₘ(L²)_{5-z}] (B)

in which
X is the same or different and is hydrogen, halogen, SnCl₃, CO, NO or R⁶—COO,
L¹ is the same or different and is hydrogen, halogen, R⁶—COO, NO, CO or a cyclopentadienyl ligand of the following general formula (2):

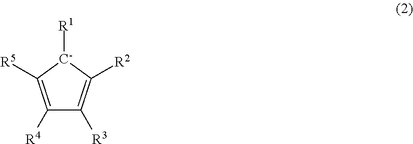

in which
R¹ to R⁵ are the same or different and are each hydrogen, methyl, ethyl, propyl, butyl, hexyl or phenyl or, alternatively, two adjacent radicals from R¹ to R⁵ are bridged, so as to result in an indenyl or fluorenyl system,
L² is a phosphine, diphosphine or arsine and
n is 0, 1 or 2,
m is 0, 1, 2 or 3,
z is 1, 2, 3 or 4, and
R⁶ is a radical which has 1 to 20 carbon atoms and may be branched or unbranched, bridged or unbridged and/or partly aromatic, and is preferably C₁-C₄ alkyl.

Examples of L¹ ligands in the general formula (B) of the cyclopentadienyl ligand type of the general formula (2) include cyclopentadienyl, pentamethylcyclopentadienyl, ethyltetramethylcyclopentadienyl, pentaphenylcyclopentadienyl, dimethyltriphenylcyclopentadienyl, indenyl and fluorenyl. The benzene rings in the L¹ ligands of the indenyl and fluorenyl type may be substituted by C₁-C₆-alkyl radicals, especially methyl, ethyl and isopropyl, C₁-C₄-alkoxy radicals, especially methoxy and ethoxy, aryl radicals, especially phenyl, and halogens, especially fluorine and chlorine. Preferred L¹ ligands of the cyclopentadienyl type are the respectively unsubstituted cyclopentadienyl, indenyl and fluorenyl radicals.

In the L¹ ligand in the general formula (B) of the (R⁶—COO) type, R⁶ includes, for example, straight-chain or branched, saturated hydrocarbyl radicals having 1 to 20, preferably 1 to 12 and especially 1 to 6 carbon atoms, cyclic saturated hydrocarbyl radicals having 5 to 12 and preferably 5 to 7 carbon atoms, and also aromatic hydrocarbyl radicals having 6 to 18 and preferably 6 to 10 carbon atoms, or aryl-substituted alkyl radicals having preferably a straight-chain or branched C₁-C₆ alkyl radical and a C₆-C₁₈ aryl radical, preferably phenyl.

The above-elucidated R⁶ radicals in (R⁶—COO) in the ligand L¹ of the general formula (B) may optionally be substituted by hydroxyl, C₁-C₆-alkoxy, C₁-C₆-carbalkoxy, fluorine, chlorine or di-C₁-C₄-alkylamino, the cycloalkyl, aryl and aralkyl radicals additionally by C₁-C₆-alkyl; alkyl, cycloalkyl and aralkyl groups may contain keto groups. Examples of the R⁶ radical are methyl, ethyl, propyl, isopropyl, tert-butyl, cyclohexyl, phenyl, benzyl and trifluoromethyl. Preferred R⁶ radicals are methyl, ethyl and tert-butyl.

The L² ligand in the general formula (B) is preferably a phosphine or diphosphine according to the general formulae (1-a) and (1-b) shown above, including the general, preferred and particularly preferred definitions given there, or is an arsine of the general formula (3)

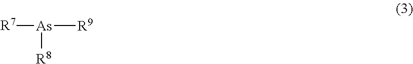

Preferred ligands L² of the general formula (3) are triphenylarsine, ditolylphenylarsine, tris(4-ethoxyphenyl)arsine, diphenylcyclohexylarsine, dibutylphenylarsine and diethylphenylarsine.

Preferred ruthenium catalysts of the general formula (B) are selected from the group which follows, where “Cp” represents cyclopentadienyl, i.e. C₅H₅⁻, “Ph” represents phenyl, “Cy” represents cyclohexyl and “dppe” represents 1,2-bis(diphenylphosphino)ethane: RuCl₂(PPh)₃; RuHCl(PPh₃)₃; RuH₂(PPh₃)₃; RuH₂(PPh₃)₄; RuH₄(PPh₃)₃; RuH(CH₃COO)(PPh₃)₃; RuH(C₂H₅COO)(PPh₃)₃; RuH(CH₃COO)₂(PPh₃)₂; RuH(NO)₂(PPh₃)₂; Ru(NO)₂(PPh₃)₂; RuCl(Cp)(PPh₃)₂; RuH(Cp)(PPh₃)₂; Ru(SnCl₃)(Cp)(PPh₃)₂; RuCl(μ⁵-C₉H₇)(PPh₃)₂; RuH(μ⁵-C₉H₇)(PPh₃)₂; Ru(SnCl₃)(μ⁵-CH₇)(PPh₃)₂; RuCl(μ⁵-C₁₃H₉)(PPh₃)₂; RuH(μ⁵-C₁₃H₉)(PPh₃)₂; Ru(SnCl₃)(μ⁵-C₁₃H₉)(PPh₃)₂; RuCl(μ⁵-C₉H₇)(dppe); RuHCl(CO)(PCy₃); RuH(NO)(CO)(PCy₃)₃; RuHCl(CO)₂(PPh₃)₂; RuCl₂(CO)(dppe) RuHCl(CO)(PCy₃), RuHCl(CO)(dppe)₂, RuH(CH₃COO)(PPh₃)₃; RuH(CH₃COO)₂(PPh₃)₂; and RuH(CH₃COO)(PPh₃)₃.

Suitable catalysts are also those of the general formula (C)

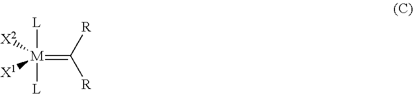

in which
M is osmium or ruthenium,
X¹ and X² are the same or different and are two ligands, preferably anionic ligands,
L are identical or different ligands, preferably uncharged electron donors,
R is the same or different and is hydrogen, alkyl, preferably C₁-C₃₀-alkyl, cycloalkyl, preferably C₃-C₃₀-cycloalkyl, alkenyl, preferably C₂-C₂₀-alkenyl, alkynyl, preferably C₂-C₂₀-alkynyl, aryl, preferably C₆-C₂₄-aryl, carboxylate, preferably C₁-C₂₀-carboxylate, alkoxy, preferably C₁-C₂₀-alkoxy, alkenyloxy, preferably C₂-C₂₀-alkenyloxy, alkynyloxy, preferably C₂-C₂₀-alkynyloxy, aryloxy, preferably C₆-C₂₄-aryloxy, alkoxycarbonyl, preferably C₂-C₂₀-alkoxycarbonyl, alkylamino, preferably C₁-C₃₀-alkylamino, alkylthio, preferably C₁-C₃₀-alkylthio, arylthio, preferably C₆-C₂₄-arylthio, alkylsulphonyl, preferably C₁-C₂₀-alkylsulphonyl, or alkylsulphinyl, preferably C₁-C₂₀-alkylsulphinyl, where all these radicals may each be substituted by one or more alkyl, halogen, alkoxy, aryl or heteroaryl radicals, or alternatively both R radicals, with incorporation of the common carbon atom to which they are bonded, are bridged to form a cyclic group which may be aliphatic or aromatic in nature, is optionally substituted and may contain one or more heteroatoms.

In one embodiment of the catalysts of the general formula (C), one R radical is hydrogen and the other R radical is C₁-C₂₀-alkyl, C₃-C₁₀-cycloalkyl, C₂-C₂₀-alkenyl, C₂-C₂₀-alkynyl, C₆-C₂₄-aryl, C₁-C₂₀-carboxylate, C₁-C₂₀-alkoxy, C₂-C₂₀-alkenyloxy, C₂-C₂₀-alkynyloxy, C₆-C₂₄-aryloxy, C₂-C₂₀-alkoxycarbonyl, C₁-C₃₀-alkylamino, C₁-C₃₀-alkylthio, C₆-C₂₄-arylthio, C₁-C₂₀-alkylsulphonyl or C₁-C₂₀-alkylsulphinyl, where all these radicals may each be substituted by one or more alkyl, halogen, alkoxy, aryl or heteroaryl radicals.

In the catalysts of the general formula (C), X¹ and X² are the same or different and are two ligands, preferably anionic ligands.

X¹ and X² may, for example, be hydrogen, halogen, pseudohalogen, straight-chain or branched C₁-C₃₀-alkyl, C₆-C₂₄-aryl, C₁-C₂₀-alkoxy, C₆-C₂₄-aryloxy, C₃-C₂₀-alkyldiketonate, C₆-C₂₄-aryldiketonate, C₁-C₂₀-carboxylate. C₁-C₂₀-alkylsulphonate, C₆-C₂₄-arylsulphonate, C₁-C₂₀-alkylthiol, C₆-C₂₄-arylthiol, C₁-C₂₀-alkylsulphonyl, C₁-C₂₀-alkylsulphinyl, mono- or dialkylamide, mono- or dialkylcarbamate, mono- or dialkylthiocarbamate, mono- or dialkyldithiocarbamate or mono- or dialkylsulphonamide radicals.

The aforementioned X₁ and X² radicals may also be substituted by one or more further radicals, for example by halogen, preferably fluorine, C₁-C₁₀-alkyl, C₁-C₁₀-alkoxy or C₆-C₂₄-aryl, where these radicals too may optionally in turn be substituted by one or more substituents selected from the group comprising halogen, preferably fluorine, C₁-C₅-alkyl, C₁-C₅-alkoxy and phenyl.

In a further embodiment, X¹ and X² are the same or different and are each halogen, especially fluorine, chlorine, bromine or iodine, benzoate, C₁-C₅-carboxylate, C₁-C₅-alkyl, phenoxy, C₁-C₅-alkoxy, C₁-C₅-alkylthiol, C₆-C₂₄-arylthiol, C₆-C₂₄-aryl or C₁-C₅-alkylsulphonate.

In a further embodiment, X¹ and X² are identical and are each halogen, especially chlorine, CF₃COO, CH₃COO, CFH₂COO, (CH₃)₃CO, (CF₃)₂(CH₃)CO, (CF₃)(CH₃)₂CO, PhO (phenoxy), MeO (methoxy), EtO (ethoxy), tosylate (p-CH₃—C₆H₄—SO₃), mesylate (CH₃SO₃) or CF₃SO₃ (trifluoromethanesulphonate).

In the general formula (C), L are identical or different ligands and are preferably uncharged electron donors.

The two L ligands may, for example, each independently be a phosphine, sulphonated phosphine, phosphate, phosphinite, phosphonite, arsine, stibine, ether, amine, amide, sulphoxide, carboxyl, nitrosyl, pyridine, thioether, an imidazoline or an imidazolidine ligand.

Preferably, the two L ligands are each independently a C₆-C₂₄-aryl-, C₁-C₁₀-alkyl- or C₃-C₂₀-cycloalkylphosphine ligand, a sulphonated C₆-C₂₄-aryl- or sulphonated C₁-C₁₀-alkylphosphine ligand, a C₆-C₂₄-aryl- or C₁-C₁₀-alkylphosphinite ligand, a C₆-C₂₄-aryl- or C₁-C₁₀-alkylphosphonite ligand, a C₆-C₂₄-aryl- or C₁-C₁₀-alkylphosphite ligand, a C₆-C₂₄-aryl- or C₁-C₁₀-alkylarsine ligand, a C₆-C₂₄-aryl- or C₁-C₁₀-alkylamine ligand, a pyridine ligand, a C₆-C₂₄-aryl or C₁-C₁₀-alkyl sulphoxide ligand, a C₆-C₂₄-aryl or C₁-C₁₀-alkyl ether ligand or a C₆-C₂₄-aryl- or C₁-C₁₀-alkylamide ligand, all of which may each be substituted by a phenyl group which is in turn either unsubstituted or substituted by one or more halogen, C₁-C₅-alkyl or C₁-C₅-alkoxy radical(s).

The term “phosphine” includes, for example, PPh₃, P(p-Tol)₃, P(o-Tol)₃, PPh(CH₃)₂, P(CF)₃, P(p-FC₆H₄)₃, P(p-CF₃C₆H₄)₃, P(C₆H₄—SO₃Na)₃, P(CH₂C₆H₄—SO₃Na)₃, P(isopropyl)₃, P(CHCH₃(CH₂CH₃))₃, P(cyclopentyl)₃, P(cyclohexyl)₃, P(neopentyl)₃ and P(neophenyl)₃, where “Ph” represents phenyl and “Tol” represents tolyl.

The term “phosphinite” includes, for example, triphenylphosphinite, tricyclohexylphosphinite, triisopropylphosphinite and methyldiphenylphosphinite.

The term “phosphite” includes, for example, triphenylphosphite, tricyclohexylphosphite, tri-tert-butylphosphite, triisopropylphosphite and methyldiphenylphosphite.

The term “stibine” includes, for example, triphenylstibine, tricyclohexylstibine and trimethylstibine.

The term “sulphonate” includes, for example, trifluoromethanesulphonate, tosylate and mesylate.

The term “sulphoxide” includes, for example, (CH₃)₂S(═O) and (C₆H₅)₂S═O.

The term “thioether” includes, for example, CH₃SCH₃, C₆H₅SCH₃, CH₃OCH₂CH₃SCH₃ and tetrahydrothiophene.

The term “pyridine” shall be understood in the context of this application as an umbrella term for all pyridine-based ligands, as specified, for example, by Grubbs in WO-A-03/011455. These include pyridine, and pyridine having mono- or polysubstitution in the form of the picolines (α-, β-, and γ-picoline), lutidines (2,3-, 2,4-, 2,5-, 2,6-, 3,4- and 3,5-lutidine), collidine (2,4,6-trimethylpyridine), trifluoromethylpyridine, phenylpyridine, 4-(dimethylamino)pyridine, chloropyridines, bromopyridines, nitropyridines, quinoline, pyrimidine, pyrrole, imidazole and phenylimidazole.

If one or both of the L ligands in formula (C) is an imidazoline and/or imidazolidine radical (also referred to collectively hereinafter as “Im” ligand(s)), the latter typically has a structure of the general formula (4a) or (4b)

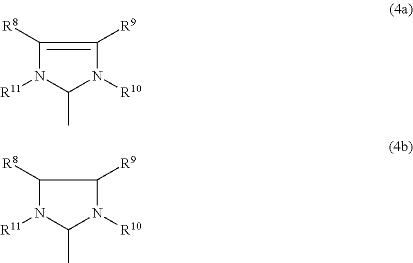

in which
R⁸, R⁹, R¹⁰, R¹¹ are the same or different and are each hydrogen, straight-chain or branched C₁-C₃₀-alkyl, C₃-C₂₀-cycloalkyl, C₂-C₂₀-alkenyl, C₂-C₂₀-alkynyl, C₆-C₂₄-aryl, C₁-C₂₀-carboxylate, C₁-C₂₀-alkoxy, C₂-C₂₀-alkenyloxy, C₂-C₂₀-alkynyloxy, C₆-C₂₀-aryloxy, C₂-C₂₀-alkoxycarbonyl, C₁-C₂₀-alkylthio, C₆-C₂₀-arylthio, C₁-C₂₀-alkylsulphonyl, C₁-C₂₀-alkylsulphonate, C₆-C₂₀-arylsulphonate or C₁-C₂₀-alkylsulphinyl.

Optionally, one or more of the R⁸, R⁹, R¹⁰, R¹¹ radicals may each independently be substituted by one or more substituents, preferably straight-chain or branched C₁-C₁₀-alkyl, C₃-C₈-cycloalkyl, C₁-C₁₀-alkoxy or C₆-C₂₄-aryl, where these aforementioned substituents may in turn be substituted by one or more radicals, preferably selected from the group of halogen, especially fluorine, chlorine or bromine, C₁-C₅-alkyl, C₁-C₅-alkoxy and phenyl.

Merely for clarification, it should be added that the structures shown in the general formulae (4a) and (4b) in the context of this application are equivalent to the structures (4a′) and (4b′) frequently also encountered in the literature for this radical, which emphasize the carbene character of the radical. This also applies analogously to the corresponding preferred structures (5a)-(5f) shown below. These radicals are all referred to collectively hereinafter as “Im” radical.

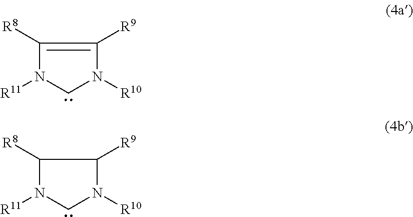

In a preferred embodiment of the catalysts of the general formula (C), R⁸ and R⁹ are each independently hydrogen, C₆-C₂₄-aryl, more preferably phenyl, straight-chain or branched C₁-C₁₀-alkyl, more preferably propyl or butyl, or form, with inclusion of the carbon atoms to which they are bonded, a cycloalkyl or aryl radical, where all the aforementioned radicals may optionally be substituted in turn by one or more further radicals selected from the group comprising straight-chain or branched C₁-C₁₀-alkyl, C₁-C₁₀-alkoxy, C₆-C₂₄-aryl and a functional group selected from the group of hydroxyl, thiol, thioether, ketone, aldehyde, ester, ether, amine, imine, amide, nitro, carboxylic acid, disulphide, carbonate, isocyanate, carbodiimide, carboalkoxy, carbamate and halogen.

In a preferred embodiment of the catalysts of the general formula (C), the R¹⁰ and R¹¹ radicals are additionally the same or different and are each straight-chain or branched C₁-C₁₀-alkyl, more preferably methyl, isopropyl or neopentyl, C₃-C₁₀-cycloalkyl, preferably adamantyl, C₆-C₂₄-aryl, more preferably phenyl, C₁-C₁₀-alkylsulphonate, more preferably methanesulphonate, C₆-C₁₀-arylsulphonate, more preferably p-toluenesulphonate.

Optionally, the aforementioned radicals as definitions of R¹⁰ and R¹¹ are substituted by one or more further radicals selected from the group comprising straight-chain or branched C₁-C₅-alkyl, especially methyl, C₁-C₅-alkoxy, aryl and a functional group selected from hydroxyl, thiol, thioether, ketone, aldehyde, ester, ether, amine, imine, amide, nitro, carboxylic acid, disulphide, carbonate, isocyanate, carbodiimide, carboalkoxy, carbamate and halogen, especially fluorine, chlorine and bromine.

More particularly, the R¹⁰ and R¹¹ radicals may be the same or different and are each isopropyl, neopentyl, adamantyl, mesityl (2,4,6-trimethylphenyl), 2,6-difluorophenyl, 2,4,6-trifluorophenyl or 2,6-diisopropylphenyl.

Particularly preferred Im radicals have the structures (5a) to (5f) below, where each Ph is a phenyl radical, Bu is a butyl radical and each Mes is a 2,4,6-trimethylphenyl radical, or Mes alternatively in all cases is 2,6-diisopropylphenyl.

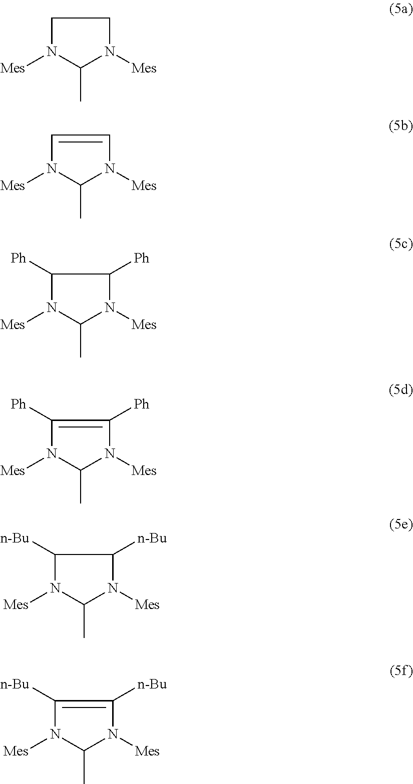

A wide variety of different representatives of the catalysts of the formula (C) is known in principle, for example from WO-A-96/04289 and WO-A-97/06185.

As an alternative to the preferred Im radicals, one or both L ligands in the general formula (C) are preferably also identical or different trialkylphosphine ligands in which at least one of the alkyl groups is a secondary alkyl group or a cycloalkyl group, preferably isopropyl, isobutyl, sec-butyl, neopentyl, cyclopentyl or cyclohexyl.

More preferably, in the general formula (C), one or both L ligands are a trialkylphosphine ligand in which at least one of the alkyl groups is a secondary alkyl group or a cycloalkyl group, preferably isopropyl, isobutyl, sec-butyl, neopentyl, cyclopentyl or cyclohexyl.

Particular preference is given to catalysts which are covered by the general formula (C) and have the structures (6) (Grubbs (I) catalyst) and (7) (Grubbs (II) catalyst), where Cy is cyclohexyl.

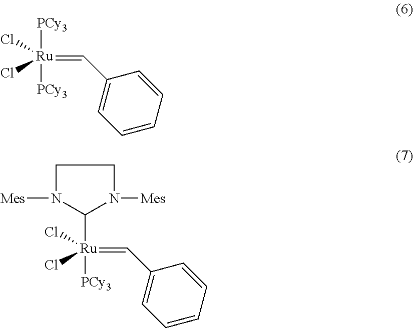

Suitable catalysts are also preferably those of the general formula (C1)

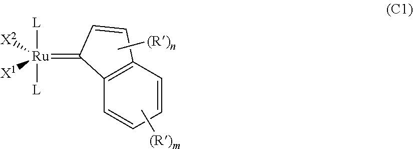

in which
X¹, X² and L may have the same general, preferred and particularly preferred definitions as in the general formula (C),
n is 0, 1 or 2,
m is 0, 1, 2, 3 or 4 and
R′ are the same or different and are each alkyl, cycloalkyl, alkenyl, alkynyl, aryl, alkoxy, alkenyloxy, alkynyloxy, aryloxy, alkoxycarbonyl, alkylamino, alkylthio, arylthio, alkylsulphonyl or alkylsulphinyl radicals, all of which may each be substituted by one or more alkyl, halogen, alkoxy, aryl or heteroaryl radicals.

An example of a preferred catalyst covered by the general formula (C1) which can be used is that of the formulae (8a) and (8b) below, where each Mes is 2,4,6-trimethylphenyl and Ph is phenyl.

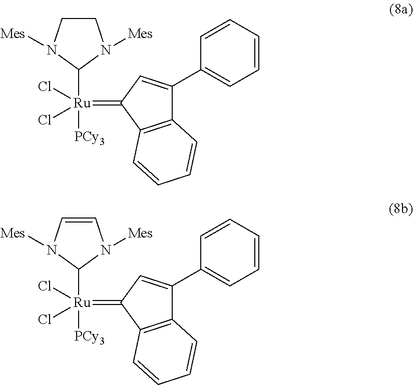

These catalysts are known, for example, from WO-A-2004/112951. Catalyst (8a) is also referred to as the Nolan catalyst.

Suitable catalysts are also preferably those of the general formula (D)

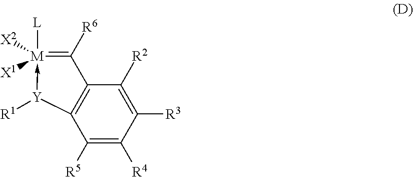

in which
M is ruthenium or osmium,
X¹ and X² are identical or different ligands, preferably anionic ligands,
Y is oxygen (O), sulphur (S), an N—R¹ radical or a P—R¹ radical, where R¹ is as defined below,
R¹ is an alkyl, cycloalkyl, alkenyl, alkynyl, aryl, alkoxy, alkenyloxy, alkynyloxy, aryloxy, alkoxycarbonyl, alkylamino, alkylthio, arylthio, alkylsulphonyl or alkylsulphinyl radical, all of which may each optionally be substituted by one or more alkyl, halogen, alkoxy, aryl or heteroaryl radicals,
R², R³, R⁴ and R⁵ are the same or different and are each hydrogen or organic or inorganic radicals,
R⁶ is hydrogen or an alkyl, alkenyl, alkynyl or aryl radical and
L is a ligand as defined for the formula (C).

The catalysts of the general formula (D) are known in principle and are described, for example, by Hoveyda et al. in US 2002/0107138 A1 and Angew. Chem. Int. Ed. 2003, 42, 4592, and by Grela in WO-A-2004/035596, Eur. J. Org. Chem 2003, 963-966 and Angew. Chem. Int. Ed. 2002, 41, 4038, and also in J. Org. Chem. 2004, 69, 6894-96 and Chem. Eur. J 2004, 10, 777-784, and also in US 2007/043180. The catalysts are commercially available or can be prepared according to the references cited.

In the catalysts of the general formula (D), L is a ligand which typically has an electron donor function and may assume the same general, preferred and particularly preferred definitions as L in the general formula (C). In addition, L in the general formula (D) is preferably a P(R⁷)₃ radical where R⁷ is independently C₁-C₆ alkyl, C₃-C₈-cycloalkyl or aryl, or else an optionally substituted imidazoline or imidazolidine radical (“Im”).

C₁-C₆-Alkyl is, for example, methyl, ethyl, n-propyl, isopropyl, n-butyl, sec-butyl, tert-butyl, n-pentyl, 1-methylbutyl, 2-methylbutyl, 3-methylbutyl, neopentyl, 1-ethylpropyl and n-hexyl.

C₃-C₈-Cycloalkyl comprises cyclopropyl, cyclobutyl, cyclopentyl, cyclohexyl, cycloheptyl and cyclooctyl.

Aryl comprises an aromatic radical having 6 to 24 skeleton carbon atoms, preferably mono-, bi- or tricyclic carbocyclic aromatic radicals having 6 to 10 skeleton carbon atoms, especially phenyl, biphenyl, naphthyl, phenanthrenyl or anthracenyl.

The imidazoline or imidazolidine radical (Im) has the same general, preferred and particularly preferred structures as the catalysts of the general formula (C).

Particularly suitable catalysts for the general formula (D) are those in which the R¹⁰ and R¹¹ radicals are the same or different and are each straight-chain or branched C₁-C₁₀-alkyl, more preferably isopropyl or neopentyl, C₃-C₁₀-cycloalkyl, preferably adamantyl, C₆-C₂₄-aryl, more preferably phenyl, C₁-C₁₀-alkylsulphonate, more preferably methanesulphonate, C₆-C₁₀-arylsulphonate, more preferably p-toluenesulphonate.

Optionally, the aforementioned radicals as definitions of R¹⁰ and R¹¹ are substituted by one or more further radicals selected from the group comprising straight-chain or branched C₁-C₅-alkyl, especially methyl, C₁-C₅-alkoxy, aryl and a functional group selected from the group of hydroxyl, thiol, thioether, ketone, aldehyde, ester, ether, amine, imine, amide, nitro, carboxylic acid, disulphide, carbonate, isocyanate, carbodiimide, carboalkoxy, carbamate and halogen.

More particularly, the R¹⁰ and R¹¹ radicals may be the same or different and are each isopropyl, neopentyl, adamantyl or mesityl.

Particularly preferred imidazoline or imidazolidine radicals (Im) have the structures (5a-5f) already specified above, where each Mes is 2,4,6-trimethylphenyl.

In the catalysts of the general formula (D), X¹ and X² have the same general, preferred and particularly preferred definitions as in the catalysts of the general formula (C).

In the general formula (D), the R¹ radical is an alkyl, cycloalkyl, alkenyl, alkynyl, aryl, alkoxy, alkenyloxy, alkynyloxy, aryloxy, alkoxycarbonyl, alkylamino, alkylthio, arylthio, alkylsulphonyl or alkylsulphinyl radical, all of which may each optionally be substituted by one or more alkyl, halogen, alkoxy, aryl or heteroaryl radicals.

Typically, the R¹ radical is a C¹-C³⁰-alkyl, C₃-C₂₀-cycloalkyl, C₂-C₂₀-alkenyl, C₂-C₂₀-alkynyl, C₆-C₂₄-aryl, C₁-C₂₀-alkoxy, C₂-C₂₀-alkenyloxy, C₂-C₂₀-alkynyloxy, C₆-C₂₄-aryloxy, C₂-C₂₀-alkoxycarbonyl, C₁-C₂₀-alkylamino, C₁-C₂₀-alkylthio, C₆-C₂₄-arylthio, C₁-C₂₀-alkylsulphonyl or C₁-C₂₀-alkylsulphinyl radical, all of which may each be substituted by one or more alkyl, halogen, alkoxy, aryl or heteroaryl radicals.

Preferably, R¹ is a C₃-C₂₀-cycloalkyl radical, a C₆-C₂₄-aryl radical or a straight-chain or branched C₁-C₃₀-alkyl radical, where the latter may optionally be interrupted by one or more double or triple bonds or else one or more heteroatoms, preferably oxygen or nitrogen. More preferably, R¹ is a straight-chain or branched C₁-C₁₂-alkyl radical.

The C₃-C₂₀-cycloalkyl radical comprises, for example, cyclopropyl, cyclobutyl, cyclopentyl, cyclohexyl, cycloheptyl and cyclooctyl.

The C₁-C₁₂-alkyl radical may, for example, be methyl, ethyl, n-propyl, isopropyl, n-butyl, sec-butyl, tert-butyl, n-pentyl, 1-methylbutyl, 2-methylbutyl, 3-methylbutyl, neopentyl, l-ethylpropyl, n-hexyl, n-heptyl, n-octyl, n-decyl or n-dodecyl. More particularly, R¹ is methyl or isopropyl.

The C₆-C₂₄-aryl radical is an aromatic radical having 6 to 24 skeleton carbon atoms. Preferred mono-, bi- or tricyclic carbocyclic aromatic radicals having 6 to 10 skeleton carbon atoms include, for example, phenyl, biphenyl, naphthyl, phenanthrenyl or anthracenyl.

In the general formula (D), the R², R³, R⁴ and R⁵ radicals are the same or different and may each be hydrogen or organic or inorganic radicals.

In a suitable embodiment, R², R³, R⁴, R⁵ are the same or different and are each hydrogen, halogen, nitro, CF₃, alkyl, cycloalkyl, alkenyl, alkynyl, aryl, alkoxy, alkenyloxy, alkynyloxy, aryloxy, alkoxycarbonyl, alkylamino, alkylthio, arylthio, alkylsulphonyl or alkylsulphinyl radicals, all of which may each optionally be substituted by one or more alkyl, alkoxy, halogen, aryl or heteroaryl radicals.

Typically, R², R³, R⁴, R⁵ are the same or different and are each hydrogen, halogen, preferably chlorine or bromine, nitro, CF₃, C₁-C₃₀-alkyl, C₃-C₂₀-cycloalkyl, C₂-C₂₀-alkenyl, C₃-C₂₀-alkynyl, C₆-C₂₄-aryl, C₁-C₂₀-alkoxy, C₂-C₂₀-alkenyloxy, C₂-C₂₀-alkynyloxy, C₆-C₂₄-aryloxy, C₂-C₂₀-alkoxycarbonyl, C₁-C₂₀-alkylamino, C₁-C₂₀-alkylthio, C₆-C₂₄-arylthio, C₁-C₂₀-alkylsulphonyl or C₁-C₂₀-alkylsulphinyl radicals, all of which may each optionally be substituted by one or more C₁-C₃₀-alkyl, C₁-C₂₀-alkoxy, halogen, C₆-C₂₄-aryl or heteroaryl radicals.

In a particularly proven embodiment, R², R³, R⁴, R⁵ are the same or different and are each nitro, straight-chain or branched C₁-C₃₀-alkyl, C₅-C₂₀-cycloalkyl, straight-chain or branched C₁-C₂₀-alkoxy radicals or C₆-C₂₄-aryl radicals, preferably phenyl or naphthyl. The C₁-C₃₀-alkyl radicals and C₁-C₂₀-alkoxy radicals may optionally be interrupted by one or more double or triple bonds or else one or more heteroatoms, preferably oxygen or nitrogen.

In addition, two or more of the R², R³, R⁴ or R⁵ radicals may also be bridged via aliphatic or aromatic structures. R³ and R⁴ may, for example, including the carbon atoms to which they are bonded in the phenyl ring of the formula (D), form a fused-on phenyl ring so as to result overall in a naphthyl structure.

In the general formula (D), the R⁶ radical is hydrogen, an alkyl, alkenyl, alkynyl or aryl radical, preferably hydrogen, a C₁-C₃₀-alkyl, a C₂-C₂₀-alkenyl, a C₂-C₂₀-alkynyl or a C₆-C₂₄-aryl radical. More preferably, R⁶ is hydrogen.

Other suitable catalysts are catalysts of the general formula (D1)

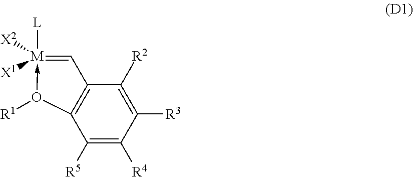

in which M, L, X¹, X², R¹, R², R³, R⁴ and R⁵ may each have the general, preferred and particularly preferred definitions given for the general formula (D).

The catalysts of the general formula (D1) are known in principle, for example, from US 2002/0107138 A1 (Hoveyda et al.) and can be obtained by preparation processes specified therein.

Particular suitable catalysts are those of the general formula (D1) where

M is ruthenium.
X¹ and X² are both halogen, especially both chlorine,
R¹ is a straight-chain or branched C₁-C₁₂ alkyl radical,
R², R³, R, R⁴, R⁵ each have the general and preferred definitions given for the general formula (D) and
L has the general and preferred definitions given for the general formula (D).

Especially suitable catalysts are those of the general formula (D1) where

M is ruthenium,
X¹ and X² are both chlorine,
R¹ is an isopropyl radical,
R², R³, R⁴, R⁵ are all hydrogen and
L is an optionally substituted imidazolidine radical of the formula (4a) or (4b),

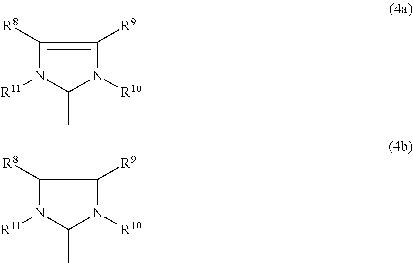

in which
R⁸, R⁹, R¹⁰, R¹¹ are the same or different and are each hydrogen, straight-chain or branched C₁-C₃₀-alkyl, C₃-C₂₀-cycloalkyl, C₂-C₂₀-alkenyl, C₂-C₂₀-alkynyl, C₆-C₂₄-aryl, C₁-C₂₀-carboxylate, C₁-C₂₀-alkoxy, C₂-C₂₀-alkenyloxy, C₂-C₂₀-alkynyloxy, C₆-C₂₄-aryloxy, C₂-C₂₀-alkoxycarbonyl, C₁-C₂₀-alkylthio, C₆-C₂₄-arylthio, C₁-C₂₀-alkylsulphonyl, C₁-C₂₀-alkylsulphonate, C₆-C₂₄-arylsulphonate or C₁-C₂₀-alkylsulphinyl, where the aforementioned radicals may each be substituted by one or more substituents, preferably straight-chain or branched C₁-C₁₀-alkyl, C₃-C₈-cycloalkyl, C₁-C₁₀-alkoxy or C₆-C₂₄-aryl, where these aforementioned substituents too may in turn be substituted by one or more radicals, preferably selected from the group of halogen, especially chlorine or bromine, C₁-C₅-alkyl, C₁-C₅-alkoxy and phenyl.

A very particularly suitable catalyst is one which is covered by the general structural formula (D1) and has the formula (9), where each Mes is 2,4,6-trimethylphenyl.

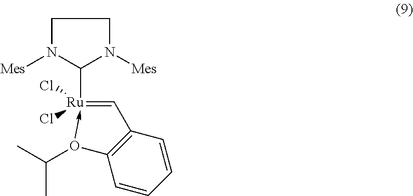

This catalyst (9) is also referred to in the literature as “Hoveyda catalyst”.

Further suitable catalysts are those which are covered by the general structural formula (D1) and have one of the following formulae (10), (11), (12), (13), (14), (15), (16) and (17), where each Mes is 2,4,6-trimethylphenyl.

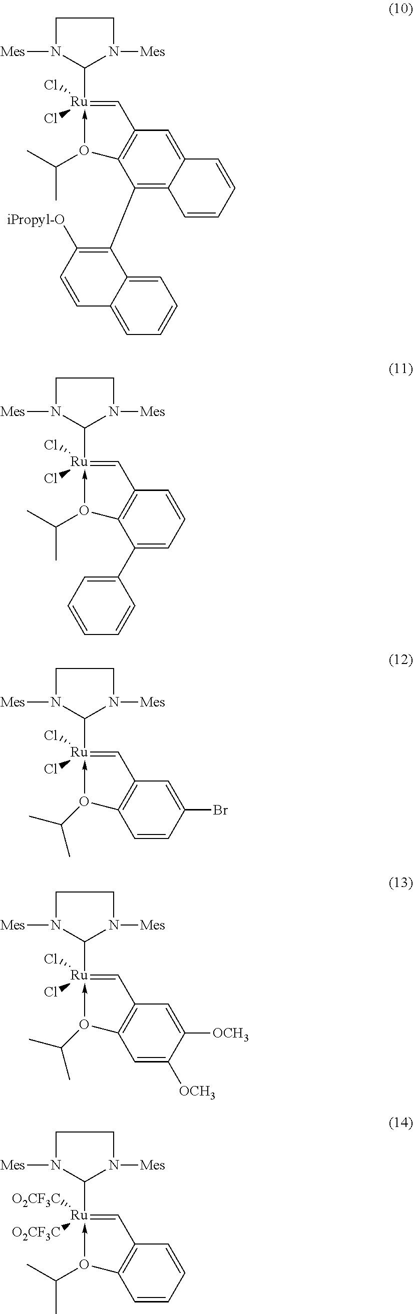

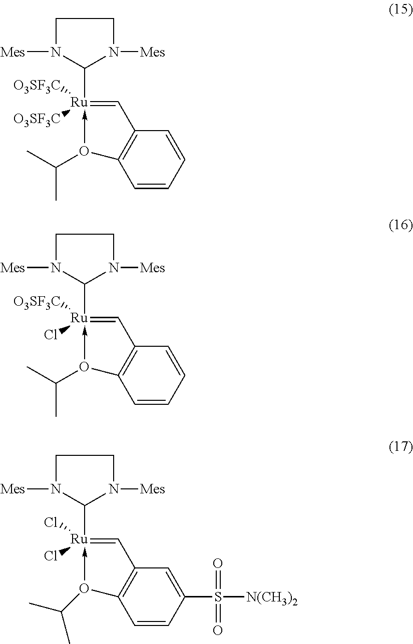

A further suitable catalyst is a catalyst of the general formula (D2)

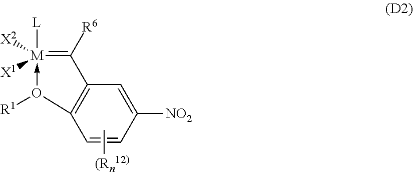

in which
M, L, X¹, X², R¹ and R⁶ each have the general and preferred definitions given for the formula (D),
R¹² are the same or different and have the general and preferred definitions given for the R², R³, R⁴ and R⁵ radicals in the formula (D), excluding hydrogen, and
n is 0, 1, 2 or 3.

The catalysts of the general formula (D2) are known in principle, for example, from WO-A-2004/035596 (Grela) and can be obtained by preparation processes specified therein.

Particular suitable catalysts are those of the general formula (D2) in which

M is ruthenium,
X¹ and X² are both halogen, especially both chlorine,
R¹ is a straight-chain or branched C₁-C₁₂ alkyl radical,
R¹² is as defined for the general formula (D2),
n is 0, 1, 2 or 3,
R⁶ is hydrogen and
L is as defined for the general formula (D).

Especially suitable catalysts are those of the general formula (D2) in which

M is ruthenium,
X¹ and X² are both chlorine,
R¹ is an isopropyl radical.
n is 0 and
L is an optionally substituted imidazolidine radical of the formula (4a) or (4b) in which R⁸, R⁹, R¹⁰, R¹¹ are the same or different and are each as defined for the especially preferred catalysts of the general formula (D1).

Particularly suitable catalysts are those of the structures (18) (“Grela catalyst”) and (19) below, where each Mes is 2,4,6-trimethylphenyl.

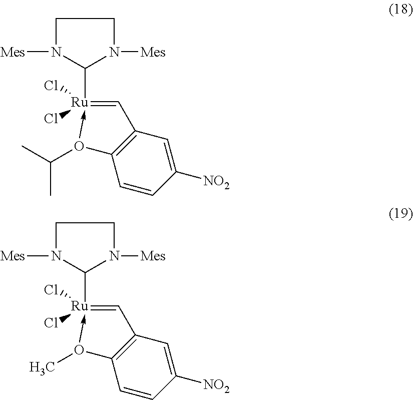

Another suitable catalyst is a dendritic catalyst of the general formula (D3)

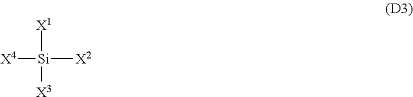

in which X¹, X², X³ and X⁴ each have a structure of the general formula (20) bonded to the silicon of the formula (D3) via the methylene group shown on the right and

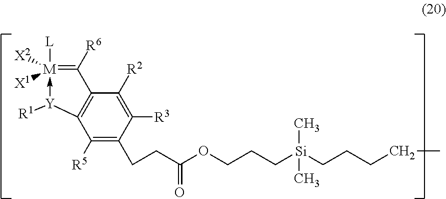

in which
M, L, X¹, X², R¹, R², R³, R⁵ and R⁶ may each have the general and preferred definitions given for the general formula (D).

The catalysts of the general formula (D3) are known from US 2002/0107138 A1 and can be prepared according to the details given therein.

Another suitable catalyst is a catalyst of the general formula (D4)

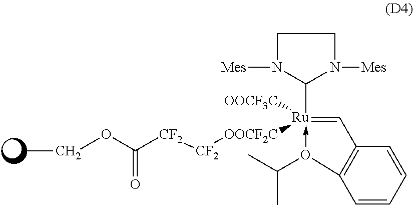

in which the symbol represents a support.

The support is preferably a poly(styrene-divinylbenzene) copolymer (PS-DVB).

The catalysts according to formula (D4) are known in principle from Chem. Eur. J. 2004 10, 777-784 and are obtainable by preparation methods described therein.

All the aforementioned catalysts of the (D), (D1), (D2), (D3) and (D4) type can either be used as such in the hydrogenation reaction or else they can be applied to a solid support and immobilized. Suitable solid phases or supports are those materials which are firstly inert with respect to the metathesis reaction mixture and secondly do not impair the activity of the catalyst. The catalyst can be immobilized using, for example, metals, glass, polymers, ceramic, organic polymer beads or else inorganic sol-gels, carbon black, silica, silicates, calcium carbonate and barium sulphate.

Other suitable catalysts are catalysts of the general formula (E)

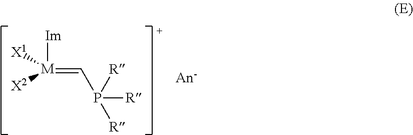

where
M is ruthenium or osmium,
X¹ and X² are the same or different and are each anionic ligands,
R″ are the same or different and are each organic radicals,
Im is an optionally substituted imidazoline or imidazolidine radical and
An is an anion.

The catalysts of the general formula (E) are known in principle (see, for example, Angew. Chem. Int. Ed. 2004, 43, 6161-6165).

X¹ and X² in the general formula (E) may have the same general, preferred and particularly preferred definitions as in the formulae (C) and (D).

The Im radical typically has a structure of the general formula (4a) or (4b) which has already been specified for the catalyst type of the formulae (C) and (D) and may also have any of the structures specified there as preferred, especially those of the formulae (5a)-(5f).

The R″ radicals in the general formula (E) are the same or different and are each a straight-chain or branched C₁-C₃₀-alkyl, C₅-C₃₀-cycloalkyl or aryl radical, where the C₁-C₃₀-alkyl radicals may optionally be interrupted by one or more double or triple bonds or else one or more heteroatoms, preferably oxygen or nitrogen.

Aryl comprises an aromatic radical having 6 to 24 skeleton carbon atoms. Preferred mono-, bi- or tricyclic carbocyclic aromatic radicals having 6 to 10 skeleton carbon atoms include, for example, phenyl, biphenyl, naphthyl, phenanthrenyl or anthracenyl.

The R″ radicals in the general formula (E) are preferably the same and are each phenyl, cyclohexyl, cyclopentyl, isopropyl, o-tolyl, o-xylyl or mesityl.

Other suitable catalysts are catalysts of the general formula (F)

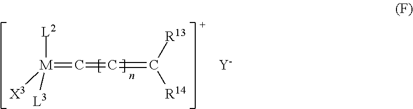

in which
M is ruthenium or osmium,
R¹³ and R¹⁴ are each independently hydrogen, C₁-C₂₀-alkyl, C₂-C₂₀-alkenyl, C₆-C₂₀-alkynyl, C₆-C₂₄-aryl, C₁-C₂₀-carboxylate, C₁-C₂₀-alkoxy, C₂-C₂₀.alkenyloxy, C₂-C₂₀-alkynyloxy, C₆-C₂₄-aryloxy, C₂-C₂₀-alkoxycarbonyl, C₁-C₂₀-alkylthio, C₁-C₂₀-alkylsulphonyl or C₁-C₂₀-alkylsulphinyl,
X³ is an anionic ligand,
L² is an uncharged π-bonded ligand, no matter whether mono- or polycyclic,
L³ is a ligand from the group of the phosphines, sulphonated phosphines, fluorinated phosphines, functionalized phosphines having up to three aminoalkyl, ammonioalkyl, alkoxyalkyl, alkoxycarbonylalkyl, hydrocarbonylalkyl, hydroxyalkyl or ketoalkyl groups, phosphites, phosphinites, phosphonites, phosphinamines, arsines, stibines, ethers, amines, amides, imines, sulphoxides, thioethers and pyridines,
Y′ is a noncoordinating anion and
n is 0, 1, 2, 3, 4 or 5.

Other suitable catalysts are catalysts of the general formula (G)

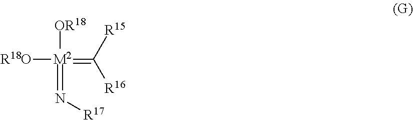

in which
M² is molybdenum,
R¹⁵ and R¹⁶ are the same or different and are each hydrogen, C₁-C₂₀-alkyl, C₂-C₂₀-alkenyl, C₂-C₂₀-alkynyl, C₆-C₂₄-aryl, C₁-C₂₀-carboxylate, C₁-C₂₀-alkoxy, C₂-C₂₀.alkenyloxy, C₂-C₂₀-alkynyloxy, C₆-C₂₄-aryloxy, C₂-C₂₀-alkoxycarbonyl, C₁-C₂₀-alkylthio, C₁-C₂₀-alkylsulphonyl or C₁-C₂₀-alkylsulphinyl,
R¹⁷ and R¹⁸ are the same or different and are each a substituted or halogen-substituted C₁-C₂₀-alkyl, C₆-C₂₄-aryl, C₆-C₃₀-aralkyl radical or silicon-containing analogues thereof.

Further suitable catalysts are catalysts of the general formula (H)

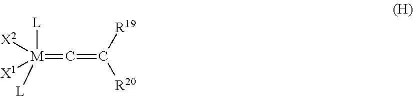

in which
M is ruthenium or osmium,
X¹ and X² are the same or different and are each anionic ligands which may assume all definitions of X¹ and X² given in the general formulae (C) and (D),
L are identical or different ligands which may assume all definitions of L given in the general formulae (C) and (D),
R¹⁹ and R²⁰ are the same or different and are each hydrogen or substituted or unsubstituted alkyl.

Further suitable catalysts are catalysts of the general formula (K), (N) or (Q)

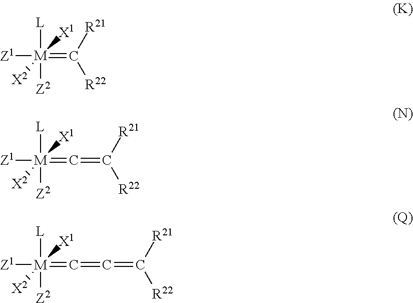

where
M is osmium or ruthenium,
X¹ and X² are the same or different and are two ligands, preferably anionic ligands,
L is a ligand, preferably an uncharged electron donor,
Z¹ and Z² are the same or different and are each uncharged electron donors,
R²¹ and R²² are each independently hydrogen, alkyl, cycloalkyl, alkenyl, alkynyl, aryl, carboxylate, alkoxy, alkenyloxy, alkynyloxy, aryloxy, alkoxycarbonyl, alkylamino, alkylthio, alkylsulphonyl or alkylsulphinyl, each of which is substituted by one or more radicals selected from alkyl, halogen, alkoxy, aryl and heteroaryl.

The catalysts of the general formulae (K), (N) and (Q) are known in principle, for example from WO 2003/011455 A1, WO 2003/087167 A2, Organometallics 2001, 20, 5314 and Angew. Chem. Int. Ed. 2002, 41, 4038. The catalysts are commercially available or else can be synthesized by the preparation methods specified in the aforementioned references.

In the catalysts of the general formulae (K), (N) and (Q), Z¹ and Z² are the same or different and are each uncharged electron donors. These ligands are typically weakly coordinating. They are typically optionally substituted heterocyclic groups. These may be five- or six-membered monocyclic groups having 1 to 4, preferably 1 to 3 and more preferably 1 or 2 heteroatoms or bi- or polycyclic structures composed of 2, 3, 4 or 5 such five- or six-membered monocyclic groups, where each of the aforementioned groups may optionally be substituted by one or more alkyl, preferably C₁-C₁₀-alkyl, cycloalkyl, preferably C₃-C₈-cycloalkyl, alkoxy, preferably C₁-C₁₀-alkoxy, halogen, preferably chlorine or bromine, aryl, preferably C₆-C₂₄-aryl, or heteroaryl, preferably C₅-C₂₃ heteroaryl radicals, each of which may again be substituted by one or more groups, preferably selected from the group consisting of halogen, especially chlorine or bromine, C₁-C₅-alkyl, C₁-C₅-alkoxy and phenyl.

Examples of Z¹ and Z² include nitrogen-containing heterocycles such as pyridines, pyridazines, bipyridines, pyrimidines, pyrazines, pyrazolidines, pyrrolidines, piperazines, indazoles, quinolines, purines, acridines, bisimidazoles, picolylimines, imidazolidines and pyrroles.

Z¹ and Z² may also be bridged to one another to form a cyclic structure. In this case, Z¹ and Z² are a single bidentate ligand.

In the catalysts of the general formulae (K), (N) and (Q), L may assume the same general, preferred and particularly preferred definitions as L in the general formulae (C) and (D).

In the catalysts of the general formulae (K), (N) and (Q), R²¹ and R²² are the same or different and are each alkyl, preferably C₁-C₃₀-alkyl, more preferably C₁-C₂₀-alkyl, cycloalkyl, preferably C₃-C₂₀-cycloalkyl, more preferably C₃-C₈-cycloalkyl, alkenyl, preferably C₂-C₂₀-alkenyl, more preferably C₂-C₁₆-alkenyl, alkynyl, preferably C₂-C₂₀-alkynyl, more preferably C₂-C₁₆-alkynyl, aryl, preferably C₆-C₂₄-aryl, carboxylate, preferably C₁-C₂₀-carboxylate, alkoxy, preferably C₁-C₂₀-alkoxy, alkenyloxy, preferably C₂-C₂₀-alkenyloxy, alkynyloxy, preferably C₂-C₂₀-alkynyloxy, aryloxy, preferably C₆-C₂₄-aryloxy, alkoxycarbonyl, preferably C₂-C₂₀-alkoxycarbonyl, alkylamino, preferably C₁-C₃₀-alkylamino, alkylthio, preferably C₁-C₃₀-alkylthio, arylthio, preferably C₆-C₂₄-arylthio, alkylsulphonyl, preferably C₁-C₂₀-alkylsulphonyl, or alkylsulphinyl, preferably C₁-C₂₀-alkylsulphinyl, where the aforementioned substituents may be substituted by one or more alkyl, halogen, alkoxy, aryl or heteroaryl radicals.

In the catalysts of the general formulae (K), (N) and (Q), X¹ and X² are the same or different and may have the same general, preferred and particularly preferred definitions as specified above for X¹ and X² in the general formula (C).

Particularly suitable catalysts are those of the general formulae (K), (N) and (Q) in which
M is ruthenium,
X¹ and X² are both halogen, especially chlorine,
R¹ and R² are the same or different and are each five- or six-membered monocyclic groups having 1 to 4, preferably 1 to 3 and more preferably 1 or 2 heteroatoms or bi- or polycyclic structures composed of 2, 3, 4 or 5 such five- or six-membered monocyclic groups, where each of the aforementioned groups may be substituted by one or more alkyl, preferably C₁-C₁₀-alkyl, cycloalkyl, preferably C₃-C₈-cycloalkyl, alkoxy, preferably C₁-C₁₀-alkoxy, halogen, preferably chlorine or bromine, aryl, preferably C₆-C₂₄-aryl, or heteroaryl, preferably C₅-C₂₃ heteroaryl radicals,
R²¹ and R²² are the same or different and are each C₁-C₃₀-alkyl, C₃-C₂₀-cycloalkyl, C₂-C₂₀-alkenyl, C₂-C₂₀-alkynyl, C₆-C₂₄-aryl, C₁-C₂₀-carboxylate, C₁-C₂₀-alkoxy, C₂-C₂₀-alkenyloxy, C₂-C₂₀-alkynyloxy, C₆-C₂₄-aryloxy, C₂-C₂₀-alkoxycarbonyl, C₁-C₃₀-alkylamino, C₁-C₃₀-alkylthio, C₆-C₂₄-arylthio, C₁-C₂₀-alkylsulphonyl, C₁-C₂₀-alkylsulphinyl, and
L has a structure of the general formula (4a) or (4b) already described above, especially of the formulae (5a) to (5f).

A very particularly suitable catalyst is one which is covered by the general formula (K) and has the structure (21)

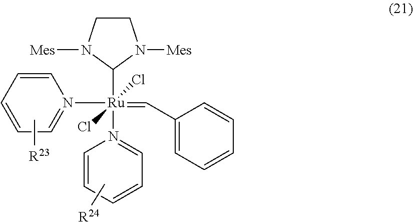

in which
R²³ and R²⁴ are the same or different and are each H, halogen, straight-chain or branched C₁-C₂₀-alkyl, C₁-C₂₀-heteroalkyl, C₁-C₁₀-haloalkyl, C₁-C₁₀-alkoxy, C₆-C₂₄-aryl, preferably phenyl, formyl, nitro, nitrogen heterocycles, preferably pyridine, piperidine and pyrazine, carboxyl, alkylcarbonyl, halocarbonyl, carbamoyl, thiocarbamoyl, carbamido, thioformyl, amino, dialkylamino, trialkylsilyl and trialkoxysilyl.

The aforementioned C₁-C₂₀-alkyl, C₃-C₂₀-heteroalkyl, C₁-C₁₀-haloalkyl, C₁-C₁₀-alkoxy, C₆-C₂₄-aryl radicals, preferably phenyl, formyl, nitro, nitrogen heterocycles, preferably pyridine, piperidine and pyrazine, carboxyl, alkylcarbonyl, halocarbonyl, carbamoyl, thiocarbamoyl, carbamido, thioformyl, amino, trialkylsilyl and trialkoxysilyl, may again each be substituted by one or more halogen, preferably fluorine, chlorine or bromine, C₁-C₅-alkyl, C₁-C₅-alkoxy or phenyl radicals.

Very particular preference is given to a catalyst in which R²³ and R²⁴ are each hydrogen (“Grubbs III catalyst”).

Also very particularly suitable are catalysts of the structures (22a) or (22b) where R²³ and R²⁴ have the same definitions as in the formula (21), except for hydrogen.

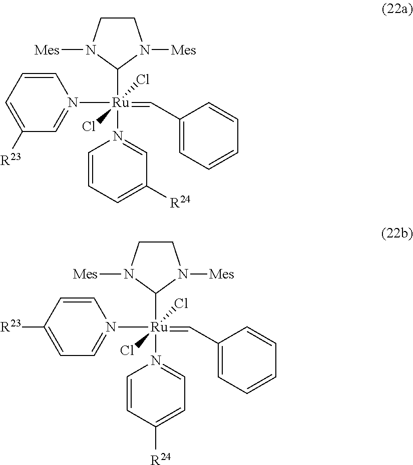

Suitable catalysts covered by the general formulae (K), (N) and (Q) have the structural formulae (23) to (34) below, where each Mes is 2,4,6-trimethylphenyl.

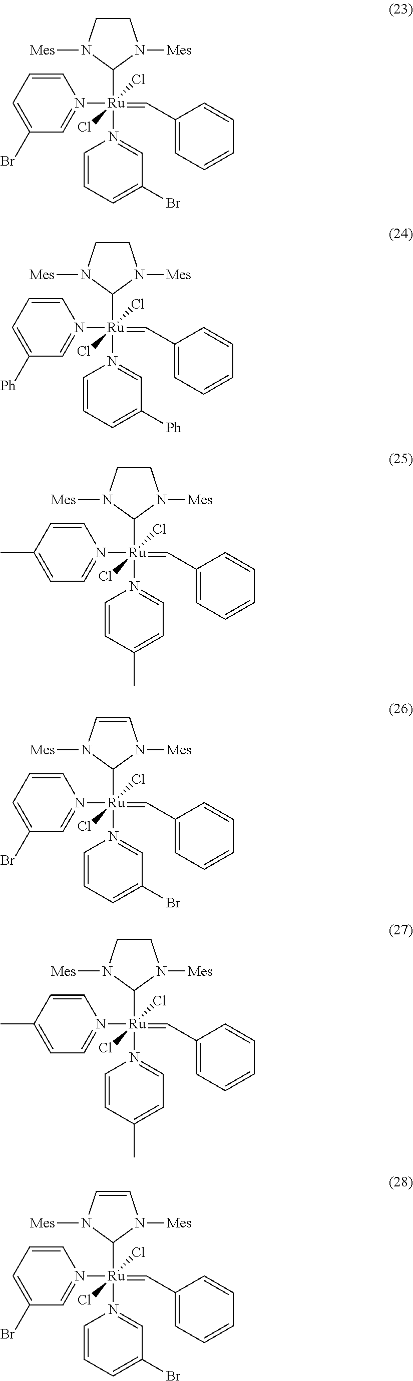

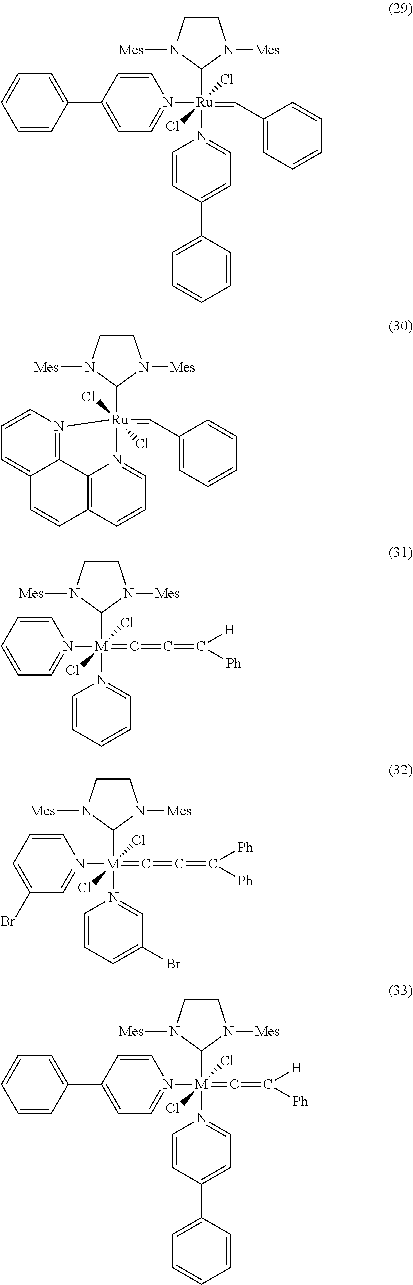

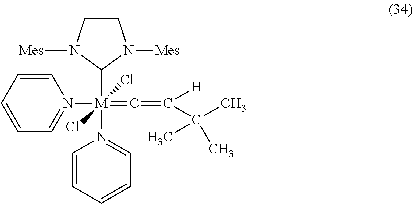

Also suitable are catalysts (R) having the general structural element (R1), where the carbon atom identified by “*” is bonded to the catalyst base skeleton via one or more double bonds,

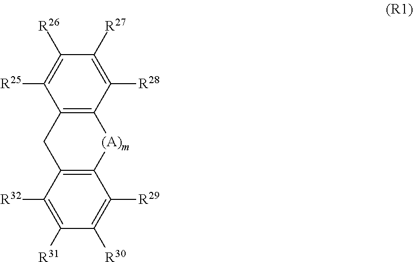

and in which
R²⁵-R³² are the same or different and are each hydrogen, halogen, hydroxyl, aldehyde, keto, thiol, CF₃, nitro, nitroso, cyano, thiocyano, isocyanato, carbodiimide, carbamate, thiocarbamate, dithiocarbamate, amino, amido, imino, silyl, sulphonate (—SO₃⁻), —OSO₃⁻, —PO₃⁻, or OPO₃⁻, or are each alkyl, cycloalkyl, alkenyl, alkynyl, aryl, carboxylate, alkoxy, alkenyloxy, alkynyloxy, aryloxy, alkoxycarbonyl, alkylamino, alkylthio, arylthio, alkylsulphonyl, alkylsulphinyl, dialkylamino, alkylsilyl or alkoxysilyl, where all these radicals may each optionally be substituted by one or more alkyl, halogen, alkoxy, aryl or heteroaryl radicals, or alternatively two directly adjacent radicals in each case from the group of R²⁵-R³², including the ring carbon atoms to which they are bonded, are bridged to form a cyclic group, preferably an aromatic system, or alternatively R⁸ is optionally bridged with another ligand of the ruthenium- or osmium-carbene complex catalyst,
m is 0 or 1 and
A is oxygen, sulphur, C(R³³R³⁴), N—R³⁵, —C(R³⁶)═C(R³⁷)—, —C(R³⁶)(R³⁸)—C(R³⁷)(R³⁹)—, in which R³³-R³⁹ are the same or different and may each have the same definitions as the R²⁵-R³² radicals.

The inventive catalysts have the structural element of the general formula (R1), where the carbon atom identified by “*” is bonded to the catalyst base skeleton via one or more double bonds. When the carbon atom identified by “*” is bonded to the catalyst base skeleton via two or more double bonds, these double bonds may be cumulated or conjugated.

Catalysts (R) of this kind are described in EP-A-2 027 920. The catalysts (R) with a structural element of the general formula (R1) include, for example, those of the following general formulae (R2a) and (R2b)

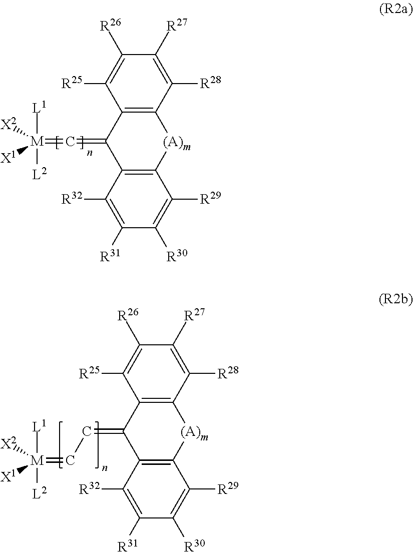

in which
M is ruthenium or osmium,
X¹ and X² are the same or different and are two ligands, preferably anionic ligands,
L¹ and L² are identical or different ligands, preferably uncharged electron donors, where L² may alternatively also be bridged to the R⁸ radical,
n is 0, 1, 2 or 3, preferably 0, 1 or 2,
n′ is 1 or 2, preferably 1, and
R²⁵-R³², m and A each have the same definitions as in the general formula (R1).

In the catalysts of the general formula (R2a), the structural element of the general formula (R2b)) is bonded to the central metal of the complex catalyst via a double bond (n=0) or via 2, 3 or 4 cumulated double bonds (in the case that n=1, 2 or 3). In the inventive catalysts of the general formula (R2b), the structural element of the general formula (R1) is bonded to the metal of the complex catalyst via conjugated double bonds. In both cases, there is a double bond in the direction of the central metal of the complex catalyst on the carbon atom identified by “*”.

The catalysts of the general formula (R2a) and (R2b) thus include catalysis in which the following general structural elements (R3)-(R9)

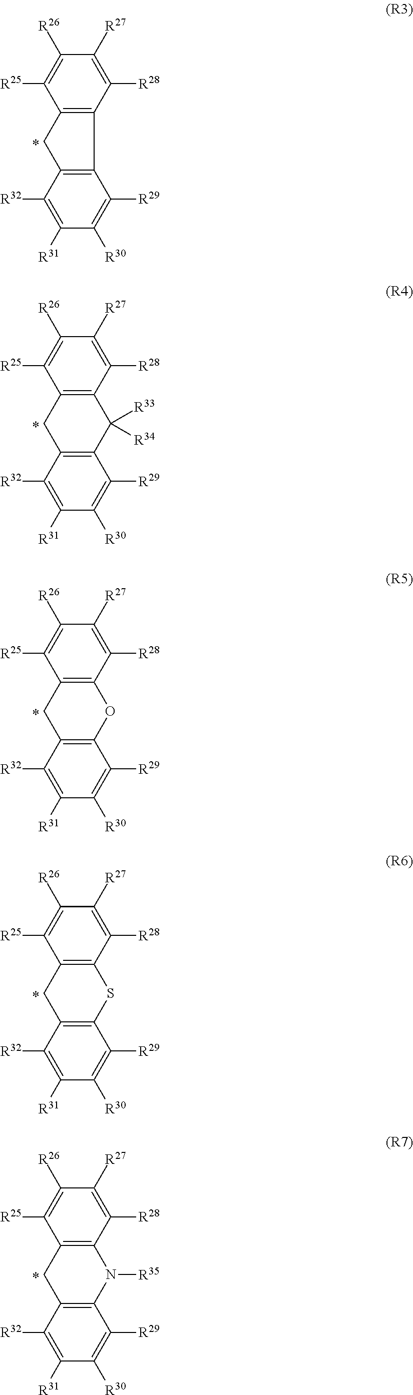

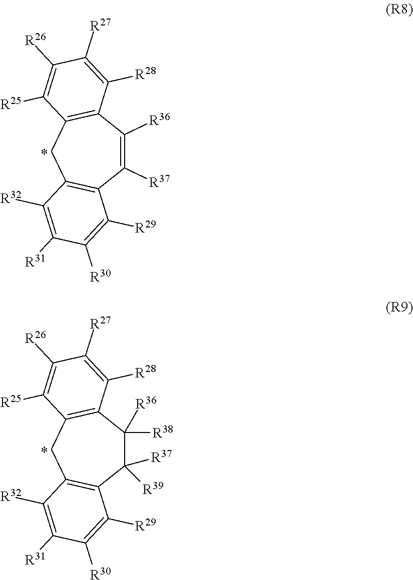

are bonded via the carbon atom identified by “*”, via one or more double bonds, to the catalyst base skeleton of the general formula (R10a) or (R10b)

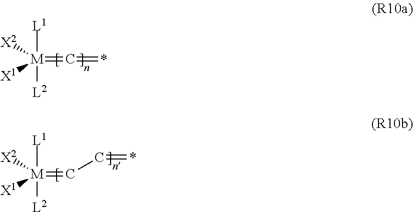

where X¹ and X², L¹ and L², n, n′ and R²⁵-R³⁹ are each as defined for the general formulae (R2a) and (R2b).

Typically, these ruthenium- or osmium-carbene catalysts are pentacoordinated.

In the structural element of the general formula (R1),
R¹⁵-R³² are the same or different and are each hydrogen, halogen, hydroxyl, aldehyde, keto, thiol, CF₃, nitro, nitroso, cyano, thiocyano, isocyanato, carbodiimide, carbamate, thiocarbamate, dithiocarbamate, amino, amido, imino, silyl, sulphonate (—SO₃⁻), —OSO₃⁻, —PO₃⁻ or OPO₃⁻, or are alkyl, preferably C₁-C₂₀-alkyl, especially C₁-C₆-alkyl, cycloalkyl, preferably C₃-C₂₀-cycloalkyl, especially C₃-C₈-cycloalkyl, alkenyl, preferably C₂-C₂₀-alkenyl, alkynyl, preferably C₂-C₂₀-alkynyl, aryl, preferably C₆-C₂₄-aryl, especially phenyl, carboxylate, preferably C₁-C₂₀-carboxylate, alkoxy, preferably C₁-C₂₀-alkoxy, alkenyloxy, preferably C₂-C₂₀-alkenyloxy, alkynyloxy, preferably C₂-C₂₀-alkynyloxy, aryloxy, preferably C₆-C₂₄-aryloxy, alkoxycarbonyl, preferably C₂-C₂₀-alkoxycarbonyl, alkylamino, preferably C₁-C₃₀-alkylamino, alkylthio, preferably C₁-C₃₀-alkylthio, arylthio, preferably C₆-C₂₄-arylthio, alkylsulphonyl, preferably C₁-C₂₀-alkylsulphonyl, alkylsulphinyl, preferably C₁-C₂₀-alkylsulphinyl, dialkylamino, preferably di(C₁-C₂₀-alkyl)amino, alkylsilyl, preferably C₁-C₂₀-alkylsilyl, or alkoxysilyl, preferably C₁-C₂₀-alkoxysilyl, radicals, where all these radicals may optionally each be substituted by one or more alkyl, halogen, alkoxy, aryl or heteroaryl radicals, or alternatively any two directly adjacent radicals from the group of R²⁵-R³², with inclusion of the ring carbon atoms to which they are bonded, may form a cyclic group by bridging, preferably an aromatic system, or alternatively R⁸ is optionally bridged with another ligand of the ruthenium- or osmium-carbene complex catalyst,
m is 0 or 1 and
A is oxygen, sulphur, C(R³³)(R³⁴), N—R³⁵, —C(R³⁶)═C(R³⁷)— or —C(R³⁶)(R³⁸)—C(R³⁷)(R³⁹)—, in which R³³-R³⁹ are the same or different and may each have the same preferred definitions as the R¹-R⁸ radicals.

C₁-C₆-Alkyl in the structural element of the general formula (R1) is, for example, methyl, ethyl, n-propyl, isopropyl, n-butyl, sec-butyl, tert-butyl, n-pentyl, 1-methylbutyl, 2-methylbutyl, 3-methylbutyl, neopentyl, 1-ethylpropyl and n-hexyl.

C₃-C₈-Cycloalkyl in the structural element of the general formula (R1) is, for example, cyclopropyl, cyclobutyl, cyclopentyl, cyclohexyl, cycloheptyl and cyclooctyl.

C₆-C₂₄-Aryl in the structural element of the general formula (R1) comprises an aromatic radical having 6 to 24 skeleton carbon atoms. Preferred mono-, bi- or tricyclic carbocyclic aromatic radicals having 6 to 10 skeleton carbon atoms include, for example, phenyl, biphenyl, naphthyl, phenanthrenyl or anthracenyl.

The X¹ and X² radicals in the structural element of the general formula (R1) have the same general, preferred and particularly preferred definitions which are specified for catalysts of the general formula (C).

In the general formulae (R2a) and (R2b) and analogously (R10a) and (R10b), the L¹ and L² radicals are identical or different ligands, preferably uncharged electron donors and may have the same general, preferred and particularly preferred definitions which are specified for catalysts of the general formula (C).

Preference is given to catalysts of the general formula (R2a) or (R2b) with a general structural unit (N1) where
M is ruthenium,
X¹ and X² are both halogen,
n is 0, 1 or 2 in the general formula (R2a) or
n′ is 1 in the general formula (R2b)
L¹ and L² are the same or different and have the general or preferred definitions specified for the general formulae (R2a) and (R2b),
R²⁵-R³² are the same or different and have the general or preferred definitions specified for the general formulae (R2a) and (R2b),
m is either 0 or 1,
and, when m=1,
A is oxygen, sulphur, C(C₁-C₁₀-alkyl), —C(C₁-C₁₀-alkyl)₂-C(C₁-C₁₀-alkyl)₂-, —C(C₁-C₁₀-alkyl)═C(C₁-C₁₀-alkyl)- or —N(C₁-C₁₀-alkyl).

Particular preference is given to catalysts of the formula (R2a) or (R2b) with a general structural unit (R1)

where
M is ruthenium,
X¹ and X² are both chlorine,
n is 0, 1 or 2 in the general formula (R2a) or
n′ is 1 in the general formula (R2b)
L¹ is an imidazolidine radical of the formulae (5a) to (5f),
L² is a sulphonated phosphine, phosphate, phosphinite, phosphonite, arsine, stibine, ether, amine, amide, sulphoxide, carboxyl, nitrosyl, pyridine radical, an imidazoline or imidazolidine radical of the formulae (5a) to (5f) or a phosphine ligand, especially PPh₃, P(p-Tol)₃, P(o-Tol)₃, PPh(CH₃)₂, P(CF₃)₃, P(p-FC₆H₄)₃, P(p-CF₃C₆H₄)₃, P(C₆H₄—SO₃Na)₃, P(CH₂C₆H₄—SO₃Na)₃, P(isopropyl)₃, P(CHCH₃(CH₂CH₃))₃, P(cyclopentyl)₃, P(cyclohexyl)₃, P(neopentyl)₃ and P(neophenyl)₃,
R²⁵-R³² have the general or preferred definitions specified for the general formulae (R2a) and (R2b),
m is either 0 or 1,
and, when m=1,
A is oxygen, sulphur, C(C₁-C₁₀-alkyl)₂, —C(C₁-C₁₀-alkyl)₂-C(C₁-C₁₀-alkyl)₂-, —C(C₁-C₁₀-alkyl)═C(C₁-C₁₀-alkyl)- or —N(C₁-C₁₀-alkyl).

In the case that the R²⁵ radical is bridged with another ligand of the catalyst of the formula R, for example for the catalysts of the general formulae (R2a) and (R2b), this gives rise to the following structures of the general formulae (R13a) and (R13b)

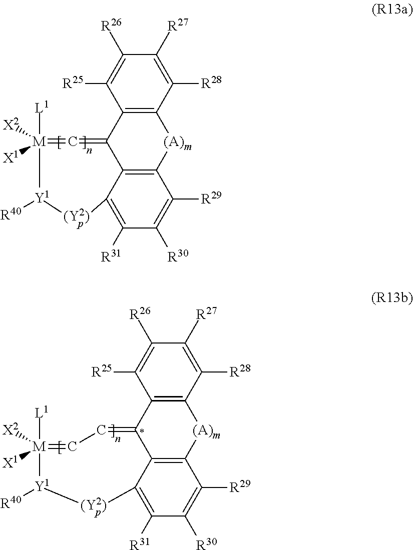

in which
Y¹ is oxygen, sulphur, an N—R⁴¹ radical or a P—R⁴¹ radical, where R⁴¹ is as defined below,
R⁴⁰ and R⁴¹ are the same or different and are each an alkyl, cycloalkyl, alkenyl, alkynyl, aryl, alkoxy, alkenyloxy, alkynyloxy, aryloxy, alkoxycarbonyl, alkylamino, alkylthio, arylthio, alkylsulphonyl or alkylsulphinyl radical, all of which may each optionally be substituted by one or more alkyl, halogen, alkoxy, aryl or heteroaryl radicals,
p is 0 or 1 and
Y² when p=1 is —(CH₂)ᵣ— where r=1, 2 or 3, —C(═O)—CH₂—, —C(═O)—, —N═CH—, —N(H)—C(═O)—, or else alternatively the overall structural unit “—Y¹(R⁴⁰)—(Y¹)ₚ—” is (—N(R⁴⁰)═CH—CH₂—), (—N(R⁴⁰,R⁴¹)═CH—CH₂—), and
   where M, X¹, X², L¹, R²⁵-R³², A, m and n have the same definitions as in the general formulae (R10a) and (R10b).

Examples of catalysts of the general formula (R) include the following structures (35) to (45):

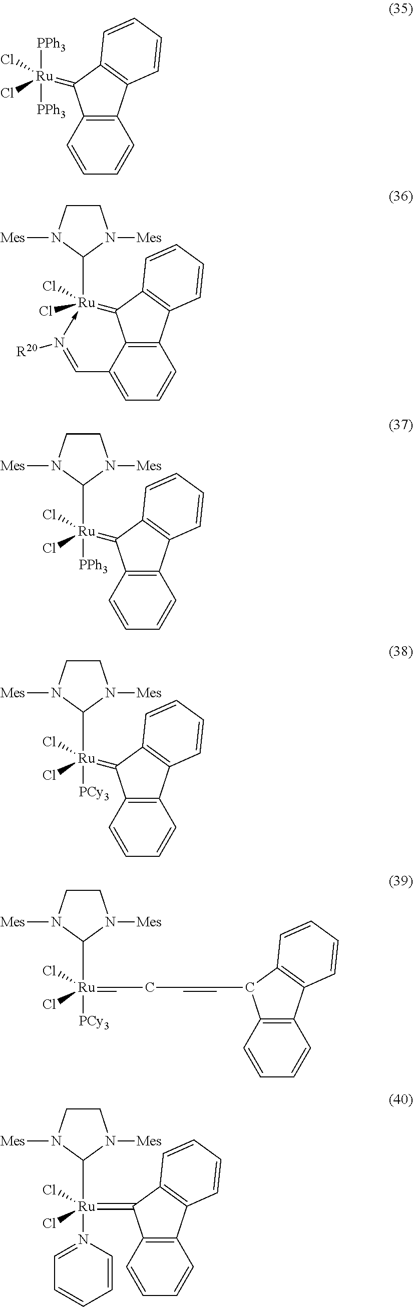

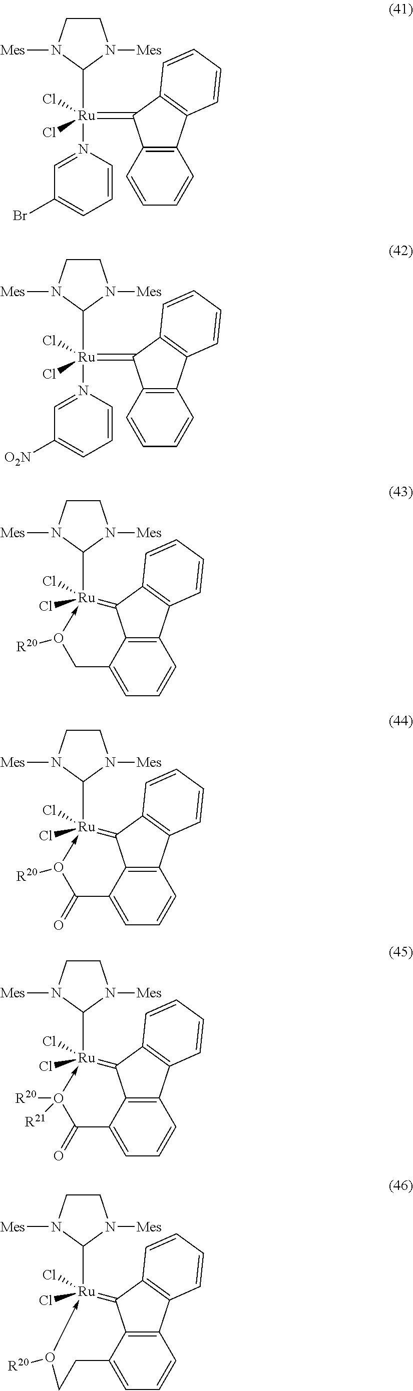

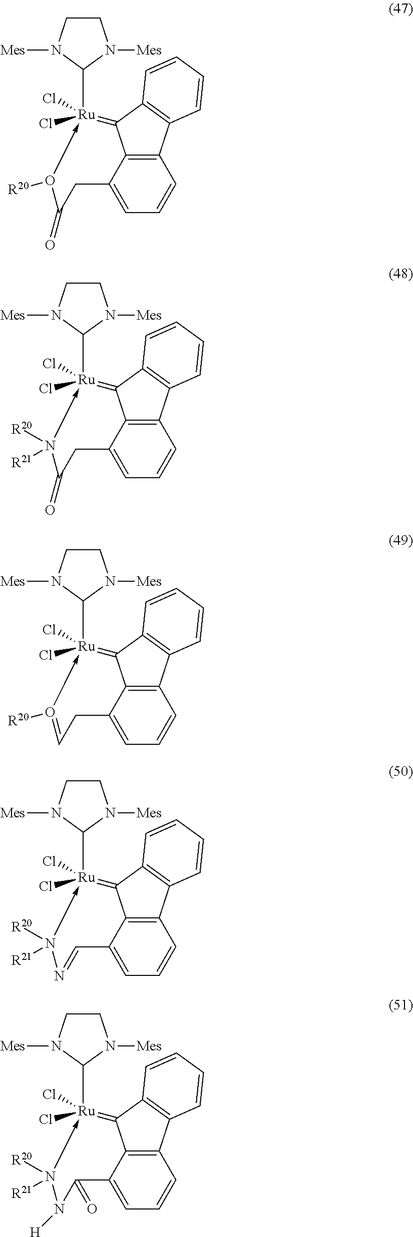

The preparation of catalysts of the general formula (R) is known from EP-A-2 027 920.

Additionally suitable are catalysts according to the general formula (T)

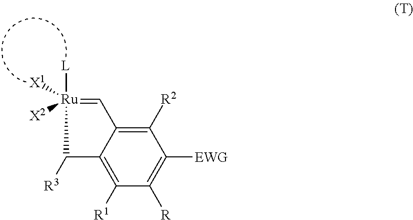

in which
X¹ and X² are the same or different and are each anionic ligands, or alternatively are joined to one another via carbon-carbon and/or carbon-heteroatom bonds,
Y is an uncharged two-electron donor selected from O, S, N and P,
R is H, halogen, alkyl, alkoxy, aryl, aryloxy, alkylcarbonyl, arylcarbonyl, alkoxycarbonyl, aryloxycarbonyl, heteroaryl, carboxyl (RCO₂⁻), cyano, nitro, amido, amino, aminosulphonyl, N-heteroarylsulphonyl, alkylsulphonyl, arylsulphonyl, alkylsulphinyl, arylsulphinyl, alkylthio, arylthio or sulphonamide,
R¹ and R² are each H, Br, I, alkyl, alkoxy, aryl, aryloxy, alkylcarbonyl, arylcarbonyl, alkoxycarbonyl, aryloxycarbonyl, carboxyl, amido, amino, heteroaryl, alkylthio, arylthio, or sulphonamido,
R³ is alkyl, aryl, heteroaryl, alkylcarbonyl, arylcarbonyl, thiocarbonyl, or aminocarbonyl,
EWG is an electron-withdrawing group selected from the group consisting of aminosulphonyl, amidosulphonyl, N-heteroarylsulphonyl, arylsulphonyl, arylsulphinyl, arylcarbonyl, alkylcarbonyl, aryloxycarbonyl, aminocarbonyl, amido, sulphonamido, chlorine, fluorine, H, or haloalkyl and
L is an electron-donating ligand joined to X¹ via carbon-carbon and/or carbon-heteroatom bonds.

These catalysts of the general formula (T) are known from US 2007/0043180.

Preference is given to catalysts of the general formula (T) in which X¹ and X² are selected from an ionic ligand in the form of halides, carboxylates and aryl oxides. More preferably, X¹ and X² are both halides, especially both chlorides. In the general formula (T), Y is preferably oxygen. R is preferably H, halogen, alkoxycarbonyl, aryloxycarbonyl, heteroaryl, carboxyl, amido, alkylsulphonyl, arylsulphonyl, alkylthio, arylthio or sulphonamido. More particularly, R is H, Cl, F or a C₁₋₈ alkoxycarbonyl group. R¹ and R² are the same or different and are preferably each H, alkoxy, aryl, aryloxy, alkoxycarbonyl, amido, alkylthio, arylthio or a sulphonamido group. More particularly, R¹ is H or an alkoxy group and R¹ is hydrogen. In the general formula (T), R³ is preferably an alkyl, aryl, heteroaryl, alkylcarbonyl or arylcarbonyl group. More preferably, R³ is isopropyl, sec-butyl and methoxyethyl. In the general formula (T), EWG is preferably an aminosulphonyl, amidosulphonyl, N-heteroarylsulphonyl, arylsulphonyl, aminocarbonyl, arylsulphonyl, alkylcarbonyl, aryloxycarbonyl, halogen or haloalkyl group. More preferably, EWG is a C₁₋₁₂ N-alkylaminosulphonyl, C₂₋₁₂ N-heteroarylsulphonyl, C₁₋₁₂ aminocarbonyl, C₆₋₁₂ arylsulphonyl, C₁₋₁₂ alkylcarbonyl, C₆₋₁₂ arylcarbonyl, C₆₋₁₂ aryloxycarbonyl, Cl, F or trifluoromethyl group. In the general formula (T), L is an electron-donating ligand selected from phosphines, amino, aryl oxides, carboxylates and heterocyclic carbene radicals which may be bonded to X¹ via carbon-carbon and/or carbon-heteroatom bonds.

A particularly suitable catalyst is one of the general formula (T) in which L is a heterocyclic carbene ligand or a phosphine (P(R⁸)₂(R⁹) having the following structures:

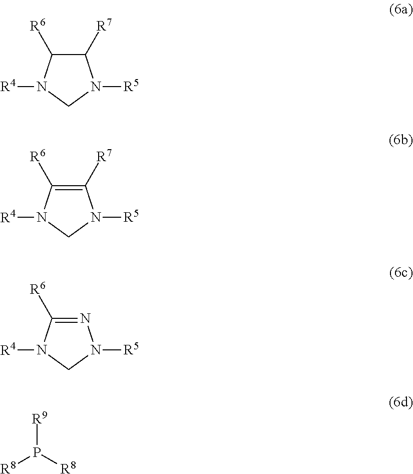

in which
R⁴ and R⁵ are the same or different and are each C₆₋₁₂ aryl and
R⁶ and R⁷ are the same or different and are each H, halogen, alkyl, alkoxy, aryl, aryloxy, alkylcarbonyl, arylcarbonyl, alkoxycarbonyl, aryloxycarbonyl, heteroaryl, carboxyl, cyano, nitro, amido, amino, alkylsulphonyl, arylsulphonyl, alkylsulphinyl, arylsulphinyl, alkylthio or sulphonamido and
R⁸ and R⁹ are the same or different and are each C₁₋₈ alkyl or C₆₋₁₂ aryl.

Additionally suitable are bimetallic complexes of the general formula (U)

M¹ₐM²_{b}Xₘ(L¹)ₙ (U)

in which
M¹ is rhodium (Rh) or ruthenium (Ru),
M² is ruthenium (Ru) or a lanthanide,
   where, when M¹ is rhodium (Rh), M² is ruthenium (Ru) or a lanthanide and, when M¹ is ruthenium (Ru), M² is a lanthanide,
X are the same or different and are each H, Cl or Br,
L¹ is an organophosphine (PR¹R²R³), diphosphine (R¹R²P(CH₂)ₙPR³R⁴), organoarsine (AsR¹R²R³) or other organic compounds containing nitrogen, sulphur, oxygen atoms or mixtures thereof, where R¹, R², R³ and R⁴ are the same or different and are each C₁-C₆ alkyl, C₆-C₁₂ cycloalkyl, aryl, C₇-C₁₂ aralkyl or aryloxy groups,
1≦a≦4,
1≦b≦2,
3≦m≦6 and
6≦n≦15.

These catalysts of the general formula (U) are known in principle from U.S. Pat. No. 6,084,033.

Particularly suitable catalysts are those of the general formula (U) in which M¹ is rhodium and M² is ruthenium. Other particularly suitable catalysts are those of the general formula (U) in which M² is a lanthanide, especially Ce or La. In particularly suitable catalysts of the general formula (U), X are the same or different and are each H or Cl. Particularly suitable catalysts of the general formula (U) are those in which L¹ is selected from trimethylphosphine, triethylphosphine, triphenylphosphine, triphenoxyphosphine, tri(p-methoxyphenyl)phosphine, diphenylethylphosphine, 1,4-di(diphenylphosphano)butane, 1,2-di(diphenylphosphano)ethane, triphenylarsine, dibutylphenylarsine, diphenylethylarsine, triphenylamine, triethylamine, N,N-dimethylaniline, diphenyl thioether, dipropyl thioether, N,N′-tetramethylethylenediamine, acetylacetone, diphenyl ketones and mixtures thereof.

Further catalysts which can be used are described in the following documents: U.S. Pat. No. 3,700,637, DE-A-25 39 132, EP-A 134 023, DE-A 35 41 689, DE 3540918, EP-A-0 298 386, DE-A 3529252, DE-A 3433 392, U.S. Pat. No. 4,464,515, U.S. Pat. No. 4,503,196 and EP-A-1 720 920.

### Amount of Hydrogenation Catalyst:

For the hydrogenation of the nitrile rubber, the hydrogenation catalyst can be used within a wide range of amounts. Typically, the catalyst is used in an amount of 0.001 to 1.0% by weight, preferably from 0.01 to 0.5% by weight, especially 0.05 to 0.3% by weight, based on the nitrile rubber to be hydrogenated.

### Other Hydrogenation Conditions:

The performance of the hydrogenation is sufficiently well known to those skilled in the art, for example from U.S. Pat. No. 6,683,136A.

### Solvent:

The hydrogenation is typically effected in a solvent, preferably an organic solvent. Suitable organic solvents are, for example, acetone, methyl ethyl ketone, ethyl acetate, tetrahydrofuran, 1,3-dioxane, benzene, toluene, methylene chloride, chloroform, monochlorobenzene and dichlorobenzene.

Monochlorobenzene has been found to be particularly useful, since it is a good solvent both for nitrile rubbers having different nitrile contents and for the corresponding resulting hydrogenated nitrile rubbers.

### Nitrile Rubber Concentration:

For the hydrogenation, the nitrile rubber is typically dissolved in at least one solvent. The concentration of the nitrile rubber in the hydrogenation is generally in the range of 1-30% by weight, preferably in the range of 5-25% by weight, more preferably in the range of 7-20% by weight.

The pressure in the hydrogenation is typically within the range from 0.1 bar to 250 bar, preferably from 5 bar to 200 bar, more preferably from 50 bar to 150 bar. The temperature is typically within the range from 0° C. to 180° C., preferably from 20° C. to 160° C. more preferably from 50° C. to 150° C. The reaction time is generally 2 to 10 h.

In the course of the hydrogenation, the double bonds present in the nitrile rubber used are hydrogenated to an extent of at least 50%, preferably 70-100%, more preferably 80-100%, even more preferably 90 to 100%, especially greater than 94.5 to 100% and especially preferred 95 to 100%. Hydrogenated nitrile rubbers having a residual content of double bonds (“RDB”) in the range from 0 to 0.9% are also obtainable. The hydrogenation is monitored online by determining the hydrogen absorption or by Raman spectroscopy (EP-A-0 897 933) or IR spectroscopy (U.S. Pat. No. 6,522,408). A suitable IR method for offline determination of the hydrogenation level is additionally described by D. Brück in Kautschuke+Gummi, Kunststoffe, Vol. 42. (1989), No. 2, p. 107-110 (part 1) and in Kautschuke+Gummi, Kunststoffe, Vol. 42. (1989), No. 3, p. 194-197.

On attainment of the desired hydrogenation level, the reactor is decompressed. Residual amounts of hydrogen are typically removed by nitrogen purging.

Before the removal of the solvent and isolation of the hydrogenated nitrile rubber from the organic phase, the hydrogenation catalyst can be, but need not be, removed. A preferred process for rhodium recovery is described, for example, in U.S. Pat. No. 4,985,540.

### Cocatalysts:

The hydrogenation can be effected with addition of a phosphine or diphosphine as a cocatalyst. The latter are generally used in amounts of 0.1 to 10% by weight, preferably of 0.25 to 5% by weight, more preferably 0.5 to 4% by weight, even more preferably 0.75 to 3.5% by weight and especially 1 to 3% by weight, based on the nitrile rubber to be hydrogenated.

Suitable phosphine cocatalysts are those of the general formula (1-a)

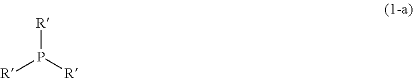

where
R′ are the same or different and are each alkyl, alkenyl, alkadienyl, alkoxy, aryl, heteroaryl, cycloalkyl, cycloalkenyl, cycloalkadienyl, halogen or trimethylsilyl,
   and suitable diphosphine cocatalysts are those of the general formula (1-b)

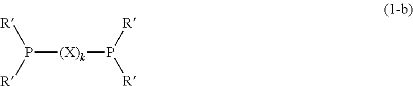

in which
R′ are the same or different and have the same definitions as in the general formula (1-a),
k is 0 or 1 and
X is a straight-chain or branched alkanediyl, alkenediyl or alkynediyl group.

The R′ radicals in both of these formulae (1-a) and (1-b) may be unsubstituted or mono- or polysubstituted.

Such phosphines or diphosphines of the general formulae (1-a) and (1-b) are preparable by methods known to those skilled in the art or else are commercially available.

Alkyl radicals in the R′ radicals of the phosphines or diphosphines of the general formulae (1-a) and (1-b) are typically understood to mean straight-chain or branched C₁-C₃₀-alkyl radicals, preferably C₁-C₃₀-alkyl radicals, more preferably C₁-C₁₈-alkyl radicals, C₁-C₁₈-alkyl comprises, for example, methyl, ethyl, n-propyl, isopropyl, n-butyl, sec-butyl, tert-butyl, n-pentyl, 1-methylbutyl, 2-methylbutyl, 3-methylbutyl, neopentyl, 1-ethylpropyl, 1,1-dimethylpropyl, 1,2-dimethylpropyl, n-hexyl, 1-methylpentyl, 2-methylpentyl, 3-methylpentyl, 4-methylpentyl, 1,1-dimethylbutyl, 1,2-dimethylbutyl, 1,3-dimethylbutyl, 2,2-dimethylbutyl, 2,3-dimethylbutyl, 3,3-dimethylbutyl, 1-ethylbutyl, 2-ethylbutyl, 1,1,2-trimethylpropyl, 1,2,2-trimethylpropyl, 1-ethyl-1-methylpropyl, 1-ethyl-2-methylpropyl, n-heptyl, n-octyl, n-nonyl, n-decyl, n-undecyl, n-dodecyl, n-tridecyl, n-tetradecyl, n-hexadecyl and n-octadecyl.

Alkenyl radicals in the R′ radicals of the phosphines or diphosphines of the general formulae (1-a) and (1-b) are typically understood to mean C₃-C₃₀-alkenyl radicals, preferably C₂-C₂₀-alkenyl radicals. More preferably, an alkenyl radical is a vinyl radical or an allyl radical.

Alkadienyl radicals in the R′ radicals of the phosphines or diphosphines of the general formulae (1-a) and (1-b) are typically understood to mean C₄-C₃₀-alkadienyl radicals, preferably C₄-C₂₀-alkadienyl radicals. More preferably, an alkadienyl radical is butadienyl or pentadienyl.

Alkoxy radicals in the R′ radicals of the phosphines or diphosphines of the general formulae (1-a) and (1-b) are typically understood to mean C₁-C₂₀-alkoxy radicals, preferably C₁-C₂₀-alkoxy radicals, more preferably methoxy, ethoxy, n-propoxy, isopropoxy, n-butoxy, sec-butoxy, tert-butoxy, n-pentoxy and n-hexoxy.

Aryl radicals in the R′ radicals of the phosphines or diphosphines of the general formulae (1-a) and (1-b) are typically understood to mean C₅-C₂₄-aryl radicals, preferably C₆-C₁₄-aryl radicals, more preferably C₆-C₁₂-aryl radicals. Examples of C₅-C₂₄-aryl are phenyl, o-, p- or m-tolyl, naphthyl, phenanthrenyl, anthracenyl and fluorenyl.

Heteroaryl radicals in the R″ radicals of the phosphines or diphosphines of the general formulae (1-a) and (1-b) have the same definition as given above for aryl radicals, except that one or more of the skeleton carbon atoms are replaced by a heteroatom selected from the group of nitrogen, sulphur and oxygen. Examples of such heteroaryl radicals are pyridinyl, oxazolyl, benzofuranyl, dibenzofuranyl and quinolinyl.

All the aforementioned alkyl, alkenyl, alkadienyl and alkoxy radicals may be unsubstituted or mono- or polysubstituted, for example by C₅-C₂₄-aryl radicals, preferably phenyl (in the case of alkyl radicals, this results, for example, in arylalkyl, preferably a phenylalkyl radical), halogen, preferably fluorine, chlorine or bromine, CN, OH, NH₂ or NR″₃ radicals where R″ in turn is C₁-C₃₀-alkyl or C₅-C₂₄-aryl.

Both the aryl radicals and the heteroaryl radicals are either unsubstituted or mono- or polysubstituted, for example by straight-chain or branched C₁-C₃₀-alkyl (resulting in what are called alkylaryl radicals), halogen, preferably fluorine, chlorine or bromine, sulphonate (SO₃Na), straight-chain or branched C₁-C₃₀-alkoxy, preferably methoxy or ethoxy, hydroxyl, NH₂ or N(R″)₂ radicals, where R″ in turn is straight-chain or branched C₁-C₃₀-alkyl or C₅-C₂₄-aryl, or by further C₅-C₂₄-aryl or -heteroaryl radicals, which results in bisaryl radicals, preferably biphenyl or binaphthyl, heteroarylaryl radicals, arylheteroaryl radicals or bisheteroaryl radicals. These C₅-C₂₄-aryl or -heteroaryl substituents too are again either unsubstituted or mono- or polysubstituted by all the aforementioned substituents.

Cycloalkyl radicals in the R′ radicals of the phosphines or diphosphines of the general formulae (1-a) and (1-b) are typically understood to mean a C₃-C₂₀-cycloalkyl radical, preferably a C₃-C₈-cycloalkyl radical, more preferably cyclopentyl and cyclohexyl.

Cycloalkenyl radicals in the R′ radicals of the phosphines or diphosphines of the general formulae (1-a) and (1-b) are the same or different, have one C═C double bond in the ring skeleton and are typically C₅-C₈ cycloalkenyl, preferably cyclopentenyl and cyclohexenyl.

Cycloalkadienyl radicals in the R″ radicals of the phosphines or diphosphines of the general formulae (1-a) and (1-b) are the same or different, have two C═C double bonds in the ring skeleton and are typically C₅-C₈ cycloalkadienyl, preferably cyclopentadienyl or cyclohexadienyl.

The aforementioned cycloalkyl, cycloalkenyl and cycloalkadienyl radicals too are either unsubstituted or mono- or polysubstituted, for example by straight-chain or branched C₁-C₃₀-alkyl (the result is then what are called alkylaryl radicals), halogen, preferably fluorine, chlorine or bromine, sulphonate (SO₃Na), straight-chain or branched C₁-C₃₀-alkoxy, preferably methoxy or ethoxy, hydroxyl, NH₂ or NR″₂ radicals, where R″ in turn is straight-chain or branched C₁-C₃₀-alkyl or C₅-C₂₄-aryl, or substituted by C₅-C₂₄-aryl or -heteroaryl radicals, which are in turn either unsubstituted or mono- or polysubstituted by all the aforementioned substituents.

The halogen radicals in the R′ radicals of the phosphines or diphosphines of the general formulae (1-a) and (1-b) are the same or different and are each fluorine, chlorine or bromine.

Particularly preferred phosphines of the general formula (1-a) are trialkyl-, tricycloalkyl-, triaryl-, trialkaryl-, triaralkyl-, diarylmonoalkyl-, diarylmonocycloalkyl-, dialkylmonoaryl-, dialkylmonocycloalkyl- or dicycloalkylmonoarylphosphines, where all the aforementioned radicals in turn are either unsubstituted or mono- or polysubstituted by the aforementioned substituents.

Especially preferred phosphines are those of the general formula (1-a) in which the R′ radicals are the same or different and are each phenyl, cyclohexyl, cyclohexenyl, cyclopentyl, cyclopentadienyl, phenylsulphonate or cyclohexylsulphonate.

Most preferably, phosphines of the general formula (1-a) used are PPh₃, P(p-Tol)₃, P(o-Tol)₃, PPh(CH)₂, P(CF₃)₃, P(p-FC₆H₄)₃, P(p-CF₃C₆H₄)₃, P(C₆H₄—SO₃Na)₃, P(CH₂C₆H₄—SO₃Na)₃, P(iso-Pr)₃, P(CHCH₃)(CH₂CH₃))₃, P(cyclopentyl)₃, P(cyclohexyl)₃, P(neopentyl)₃, P(C₆H₅CH₂)(C₆H₅)₂, P(NCCH₂CH₂)₂(C₆H₅), P[(CH₃)₃C]₂Cl, P[(CH₃)₃C]₂(CH₃), P(tert-Bu)₂(biph), P(C₆H₁₁)₂Cl, P(CH₃)(OCH₂CH₃)₂, P(CH₂═CHCH₃)₃, P(C₄H₃O)₃, P(CH₂OH)₃, P(m-CH₃OC₆H₄)₃, P(C₆F₅)₃, P[(CH₃)₃Si]₃, P[(CH₃O)₃C₆H₂]₃, where Ph is phenyl, Tol is tolyl, biph is biphenyl, Bu is butyl and Pr is propyl. Triphenylphosphine is especially preferred.

In the diphosphines of the general formula (1-b), k is 0 or 1, preferably 1,

X in the general formula (1-b) is a straight-chain or branched alkanediyl, alkenediyl or alkynediyl group, preferably a straight-chain or branched C₁-C₂₀-alkanediyl, C₂-C₂₀-alkenediyl or C₂-C₂₀-alkynediyl group, more preferably a straight-chain or branched C₁-C₈-alkanediyl, C₂-C₆-alkenediyl or C₂-C₆-alkynediyl group.

C₁-C₈-Alkanediyl is a straight-chain or branched alkanediyl radical having 1 to 8 carbon atoms. Particular preference is given to a straight-chain or branched alkanediyl radical having 1 to 6 carbon atoms, especially having 2 to 4 carbon atoms. Preference is given to methylene, ethylene, propylene, propane-1,2-diyl, propane-2,2-diyl, butane-1,3-diyl, butane-2,4-diyl, pentane-2,4-diyl and 2-methylpentane-2,4-diyl.

C₂-C₆-Alkenediyl is a straight-chain or branched alkenediyl radical having 2 to 6 carbon atoms. Preference is given to a straight-chain or branched alkenediyl radical having 2 to 4, more preferably 2 or 3, carbon atoms. Preferred examples include: vinylene, allylene, prop-1-ene-1,2-diyl and but-2-ene-1,4-diyl.

C₂-C₆-Alkynediyl is a straight-chain or branched alkynediyl radical having 2 to 6 carbon atoms. Preference is given to a straight-chain or branched alkynediyl radical having 2 to 4, more preferably 2 or 3, carbon atoms. Preferred examples include: ethynediyl and propynediyl.

Particularly preferred diphosphines of the general formula (1-b) are Cl₂PCH₂CH₂PCl₂, (C₆H₁₁)₂PCH₂P(C₆H₁₁), (CH₃)₂PCH₂CH₂P(CH₃)₂, (C₆H₅)₂PCCP(C₆H₅)₂, (C₆H₅)₂PCH═CHP(C₆H₅)₂, (C₆F₅)₂P(CH₂)₂P(C₆F₅)₂, (C₆H₅)₂P(CH₂)₂P(C₆H₅)₂, (C₆H₅)₂P(CH₂)₃P(C₆H₅)₂, (C₆H₅)₂P(CH₂)₄P(C₆H₅)₂, (C₆H₅)₂P(CH₂)₅P(C₆H₅)₂, (C₆H₅)₂PCH(CH₃)CH(CH₃)P(C₆H₅)₂ and (C₆H₅)₂PCH(CH₃)CH₂P(C₆H₅)₂.

Particular diphosphines likewise usable in accordance with the invention are also published in Chem. Eur. J. 2008, 14, 9491-9494. Examples include:

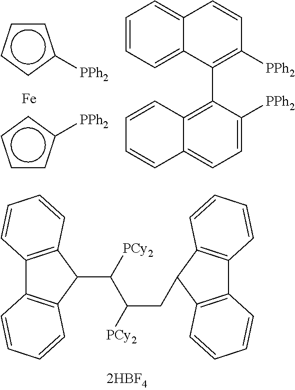

If the hydrogenation in the process according to the invention is effected with addition of a phosphine or diphosphine, these are typically used in amounts of 0.1 to 10% by weight, preferably of 0.25 to 5% by weight, more preferably 0.5 to 4% by weight, even more preferably 0.75 to 3.5% by weight and especially 1 to 3% by weight, based on the nitrile rubber to be hydrogenated.

Based on 1 equivalent of the hydrogenation catalyst, the phosphine or diphosphine, in a tried and trusted manner, is used in an amount in the range from 0.1 to 10 equivalents, preferably in the range from 0.2 to 5 equivalents and more preferably in the range from 0.3 to 3 equivalents.

The weight ratio of the added phosphine or diphosphine to the hydrogenation catalyst is typically (1-100):1, preferably (3-30):1, especially (5-15):1.

It is also possible to subject the nitrile rubber to a metathesis reaction before the hydrogenation, in order to lower the molecular weight of the nitrile rubber. The metathesis of nitrile rubbers is sufficiently well known to those skilled in the art. If a metathesis is effected, it is also possible to conduct the subsequent hydrogenation in situ, i.e. in the same reaction mixture in which the metathesis degradation has also been effected beforehand and without the need to isolate the degraded nitrile rubber. The hydrogenation catalyst is simply added to the reaction vessel.

After the hydrogenation, the solvent is removed either by a dry workup, preferably via a roller drying process or a screw process, or by a wet workup, preferably via a steam distillation.

Dry workup processes are, for example, the roller drying process described in DE 4032598 and the screw processes described in WO-A-2011/023763 and in EP-A-2368917.

A wet workup by means of a steam distillation is also suitable for the removal of the solvent used in the hydrogenation. In the case of solvent removal by steam distillation, the rubber obtained therein is removed from the aqueous crumb dispersion with sieves, for example agitated sieves or curved sieves, and subsequently mechanically dewatered and then dried. Suitable equipment for the mechanical dewatering of the water-moist rubber crumbs includes screw units, for example strainer or expeller screws. The subsequent thermal drying can be performed in expander screws or in fluidized bed dryers, belt dryers or other suitable dryers. One possible example of a steam distillation is the in the as yet unpublished application by the same applicant.

In the workup, 90-100% of the phenol of the general formula (II) used remains in the rubber.

In a particular embodiment, the inventive fully or partly hydrogenated nitrile rubber in the dried state contains volatile fractions <1.0% by weight, in which case the at least one substituted phenol of the general formula (I) is present in an amount within the range from 0.1% by weight to 0.25% by weight based on the hydrogenated nitrile rubber.

### Vulcanizable Mixtures:

The invention further provides vulcanizable mixtures comprising at least one inventive hydrogenated nitrile rubber and at least one crosslinking system. These vulcanizable mixtures may preferably also comprise one or more further typical rubber additives.

These vulcanizable mixtures are produced by mixing at least one inventive hydrogenated nitrile rubber (i) with at least one crosslinking system (ii) and optionally one or more further additives.

The crosslinking system comprises at least one crosslinker and optionally one or more crosslinking accelerators.

Typically, the inventive hydrogenated nitrile rubber is first mixed with all the additives selected, and the crosslinking system composed of at least one crosslinker and optionally a crosslinking accelerator is the last to be mixed in.

These vulcanizable mixtures are prepared by mixing at least one inventive hydrogenated nitrile rubber and at least one crosslinker. If one or more fillers and/or one or more further additives are used, these are also mixed in.

Useful crosslinkers include, for example, peroxidic crosslinkers such as bis(2,4-dichlorobenzyl) peroxide, dibenzoyl peroxide, bis(4-chlorobenzoyl) peroxide, 1,1-bis(t-butylperoxy)-3,3,5-trimethylcyclohexane, tert-butyl perbenzoate, 2,2-bis(t-butylperoxy)butene, 4,4-di-tert-butyl peroxynonylvalerate, dicumyl peroxide, 2,5-dimethyl-2,5-di(t-butylperoxy)hexane, tert-butyl cumyl peroxide, 1,3-bis(t-butylperoxyisopropyl)benzene, di-t-butyl peroxide and 2,5-dimethyl-2,5-di(t-butylperoxy)-3-hexyne.

It may be advantageous to use, as well as these peroxidic crosslinkers, also further additions which can help to increase the crosslinking yield: Suitable examples thereof include triallyl isocyanurate, triallyl cyanurate, trimethylolpropane tri(meth)acrylate, triallyltrimellitate, ethylene glycol dimethacrylate, butanediol dimethacrylate, trimethylolpropane trimethacrylate, zinc diacrylate, zinc dimethacrylate, 1,2-polybutadiene or N,N′-m-phenylenedimaleimide.

The total amount of the crosslinker(s) is typically in the range from 1 to 20 phr, preferably in the range from 1.5 to 15 phr and more preferably in the range from 2 to 10 phr, based on the unhydrogenated or fully or partly hydrogenated nitrile rubber.

The crosslinkers used may also be sulphur in elemental soluble or insoluble form, or sulphur donors.

Useful sulphur donors include, for example, dimorpholyl disulphide (DTDM), 2-morpholinodithiobenzothiazole (MBSS), caprolactam disulphide, dipentamethylenethiuram tetrasulphide (DPTT) and tetramethylthiuram disulphide (TMTD).

It is also possible to use further additions which can help to increase the crosslinking yield in the sulphur vulcanization of the inventive unhydrogenated or fully or partly hydrogenated nitrile rubbers. In principle, the crosslinking can also be effected with sulphur or sulphur donors alone.

Conversely, crosslinking of the inventive unhydrogenated or fully or partly hydrogenated nitrile rubber can also be effected only in the presence of the abovementioned additions, i.e. without addition of elemental sulphur or sulphur donors.

Suitable additions which can help to increase the crosslinking yield are, for example, dithiocarbamates, thiurams, thiazoles, sulphenamides, xanthogenates, guanidine derivatives, caprolactams and thiourea derivatives.

Dithiocarbamates used may be, for example: ammonium dimethyldithiocarbamate, sodium diethyldithiocarbamate (SDEC), sodium dibutyldithiocarbamate (SDBC), zinc dimethyldithiocarbamate (ZDMC), zinc diethyldithiocarbamate (ZDEC), zinc dibutyldithiocarbamate (ZDBC), zinc ethylphenyldithiocarbamate (ZEPC), zinc dibenzyldithiocarbamate (ZBEC), zinc pentamethylenedithiocarbamate (Z5MC), tellurium diethyldithiocarbamate, nickel dibutyldithiocarbamate, nickel dimethyldithiocarbamate and zinc diisononyldithiocarbamate.

Thiurams used may be, for example, tetramethylthiuram disulphide (TMTD), tetramethylthiuram monosulphide (TMTM), dimethyldiphenylthiuram disulphide, tetrabenzylthiuram disulphide, dipentamethylenethiuram tetrasulphide or tetraethylthiuram disulphide (TETD).

Thiazoles used may be, for example, 2-mercaptobenzothiazole (MBT), dibenzothiazyl disulphide (MBTS), zinc mercaptobenzothiazole (ZMBT) or copper 2-mercaptobenzothiazole.

Sulphenamide derivatives used may be, for example, N-cyclohexyl-2-benzothiazylsulphenamide (CBS), N-tert-butyl-2-benzothiazylsulphenamide (TBBS), N,N′-dicyclohexyl-2-benzothiazylsulphenamide (DCBS), 2-morpholinothiobenzothiazole (MBS), N-oxydiethylenethiocarbamyl-N-tert-bueylsulphenamide or oxydiethylenethiocarbamyl-N-oxyethylenesulphenamide.

Xanthogenates used may be, for example, sodium dibutylxanthogenate, zinc isopropyldibutylxanthogenate or zinc dibutylxanthogenate.

Guanidine derivatives used may be, for example, diphenylguanidine (DPG), di-o-tolylguanidine (DOTG) or o-tolylbiguanide (OTBG).

Dithiophosphates used may be, for example, zinc di(C₂-C₁₆)alkyldithiophosphaes, copper di(C₂-C₁₆)alkyldithiophosphates and dithiophosphoryl polysulphide.

A caprolactam used may be, for example, dithiobiscaprolactam.

Thiourea derivatives used may be, for example, N,N′-diphenylthiourea (DPTU), diethylthiourea (DETU) and ethylenethiourea (ETU).

Equally suitable as additions are, for example, zinc diaminodiisocyanate, hexamethylenetetramine, 1,3-bis(citraconimidomethyl)benzene and cyclic disulphanes.

The additions and crosslinking agents mentioned can be used either individually or in mixtures. Preference is given to using the following substances for the crosslinking of the nitrile rubbers: sulphur, 2-mercaptobenzothiazole, tetramethylthiuram disulphide, tetramethylthiuram monosulphide, zinc dibenzyldithiocarbamate, dipentamethylenethiuram tetrasulphide, zinc dialkyldithiophosphate, dimorpholyl disulphide, tellurium diethyldithiocarbamate, nickel dibutyldithiocarbamate, zinc dibutyldithiocarbamate, zinc dimethyldithiocarbamate and dithiobiscaprolactam.

The crosslinking agents and aforementioned additions can each be used in amounts of about 0.05 to 10 phr, preferably 0.1 to 8 phr, especially 0.5 to 5 phr (single dose, based in each case on the active substance).

In the case of sulphur crosslinking, it is possible, in addition to the crosslinking agents and abovementioned additions, also to use further inorganic or organic substances as well, such as zinc oxide, zinc carbonate, lead oxide, magnesium oxide, saturated or unsaturated organic fatty acids and zinc salts thereof, polyalcohols, amino alcohols, for example triethanolamine, and amines, for example dibutylamine, dicyclohexylamine, cyclohexylethylamine and polyether amines.

If the inventive hydrogenated nitrile rubbers are those including repeating units of one or more termonomers containing carboxyl groups, crosslinking can also be effected via the use of a polyamine crosslinker, preferably in the presence of a crosslinking accelerator. The polyamine crosslinker is not restricted, provided that it is either (1) a compound that contains two or more amino groups (optionally also in salt form) or (2) a species that forms a compound that comprises two or more amino groups in situ during the crosslinking reaction. Preference is given to using an aliphatic or aromatic hydrocarbon compound in which at least two hydrogen atoms are replaced either by amino groups or else by hydrazide structures (the latter being a “—C(═O)NHNH₂” structure).

Examples of such polyamine crosslinkers (ii) are:
aliphatic polyamines, preferably hexamethylenediamine, hexamethylenediamine carbamate, tetramethylenepentamine, hexamethylenediamine-cinnamaldehyde adduct or hexamethylenediamine dibenzoate;
aromatic polyamines, preferably 2,2-bis(4-(4-aminophenoxy)phenyl)propane, 4,4′-methylenedianiline, m-phenylenediamine, p-phenylenediamine or 4,4′-methylenebis(o-chloroaniline);
compounds having at least two hydrazide structures, preferably isophthalic dihydrazide, adipic dihydrazide or sebacic dihydrazide.

Particular preference is given to hexamethylenediamine and hexamethylenediamine carbamate.

The amount of the polyamine crosslinker in the vulcanizable mixture is typically in the range from 0.2 to 20 parts by weight, preferably in the range from 1 to 15 parts by weight and more preferably in the range from 1.5 to 10 parts by weight, based on 100 parts by weight of the hydrogenated nitrile rubber.

Crosslinking accelerators used in combination with the polyamine crosslinker may be any known to those skilled in the art, preferably a basic crosslinking accelerator. Usable examples include tetramethylguanidine, tetraethylguanidine, diphenylguanidine, di-otolylguanidine (DOTG), o-tolylbiguanidine and di-o-tolylguanidine salt of dicatecholboric acid. Additionally usable are aldehyde amine crosslinking accelerators, for example n-butylaldehydeaniline. Any crosslinking accelerator used is more preferably at least one bi- or polycyclic aminic base. These are known to those skilled in the art. The following are especially suitable: 1,8-diazabicyclo[5.4.0]undec-7-ene (DBU), 1,5-diazabicyclo[4.3.0]-5-nonene (DBN), 1,4-diazabicyclo[2.2.2]octane (DABCO), 1,5,7-triazabicyclo[4.4.0]dec-5-ene (TBD), 7-methyl-1,5,7-triazabicyclo[4.4.0]dec-5-ene (MTBD).

The amount of the crosslinking accelerator in this case is typically within a range from 0.5 to 10 parts by weight, preferably 1 to 7.5 parts by weight, especially 2 to 5 parts by weight, based on 100 parts by weight of the hydrogenated nitrile rubber.

The vulcanizable mixture based on the inventive hydrogenated nitrile rubber may in principle also contain scorch retardants, which differ between vulcanization with sulphur and with peroxides:

In the case of vulcanization with sulphur, the following are used: cyclohexylthiophthalimide (CTP), N,N′-dinitrosopentamethylenetetramine (DNPT), phthalic anhydride (PTA) and diphenylnitrosamine. Preference is given to cyclohexylthiophthalimide (CTP).

In the case of vulcanization with peroxides, scorch is retarded using compounds as specified in WO-A-97/01597 and U.S. Pat. No. 4,857,571. Preference is given to sterically hindered p-dialkylaminophenols, especially Ethanox 703 (Sartomer).

The further customary rubber additives include, for example, the typical substances known to those skilled in the art, such as fillers, filler activators, antiozonants, ageing stabilizers, antioxidants, processing aids, extender oils, plasticizers, reinforcing materials and mould release agents.

Fillers used may, for example, be carbon black, silica, barium sulphate, titanium dioxide, zinc oxide, calcium oxide, calcium carbonate, magnesium oxide, aluminium oxide, iron oxide, aluminium hydroxide, magnesium hydroxide, aluminium silicates, diatomaceous earth, talc, kaolins, bentonites, carbon nanotubes, Teflon (the latter preferably in powder form) or silicates. The fillers are typically used in amounts in the range from 5 to 350 parts by weight, preferably from 5 to 300 parts by weight, based on 100 parts by weight of the hydrogenated nitrile rubber.

Useful filler activators include organic silanes in particular, for example bis(triethoxysilylpropyl tetrasulphide), bis(triethoxysilylpropyl disulphide), vinyltrimethyloxysilane, vinyldimethoxymethylsilane, vinyliriethoxysilane, vinyltris(2-methoxyethoxy)silane, N-cyclohexyl-3-aminopropyltrimethoxysilane, 3-aminopropyltrimethoxysilane, methyltrimethoxysilane, methyltriethoxysilane, dimethyldimethoxysilane, dimethyldiethoxysilane, trimethylethoxysilane, isooctyltrimethoxysilane, isooctyltriethoxysilane, hexadecyltrimethoxysilane or (octadecyl)methyldimethoxysilane. Further filler activators are, for example, interface-active substances such as triethanolamine and ethylene glycols with molecular weights of 74 to 10 000 g/mol. The amount of filler activators is typically from 0 to 10 phr, based on 100 phr of the nitrile rubber.

Examples of useful mould release agents include saturated or partly unsaturated fatty acids and oleic acids and derivatives thereof (fatty acid esters, fatty acid salts, fatty alcohols, fatty acid amides), which are preferably used as a mixture constituent, and also products applicable to the mould surface, for example products based on low molecular weight silicone compounds, products based on fluoropolymers and products based on phenol resins.

The mould release agents are used as a mixture constituent in amounts from about 0 to 10 phr, preferably 0.5 to 5 phr, based on 100 phr of the nitrile rubber.

Another possibility is reinforcement with strengthening agents (fibres) made of glass, according to the teaching of U.S. Pat. No. 4,826,721, and another is reinforcement by cords, woven fabrics, fibres made of aliphatic and aromatic polyamides (Nylon®, Aramid®), polyesters and natural fibre products.

The mixing of the components for the purpose of producing the vulcanizable mixtures is typically effected either in an internal mixer or on a roller. Internal mixers used are typically those having what is called an intermeshing rotor geometry. At the starting point, the internal mixer is charged with the inventive nitrile rubber. This is typically in bale form and in that case is first comminuted. After a suitable period, which can be fixed by the person skilled in the art without difficulty, the additives are added, and typically, at the end, the crosslinking system. The mixing is effected under temperature control, with the proviso that the mixture remains at a temperature in the range from 100 to 150° C. for a suitable time. After a suitable mixing period, the internal mixer is vented and the shaft is cleaned. After a further period, the internal mixer is emptied to obtain the vulcanizable mixture. All the aforementioned periods are typically in the region of a few minutes and can be fixed by the person skilled in the art without difficulty as a function of the mixture to be produced. If rollers are used as mixing units, it is possible to proceed in an analogous manner and sequence in the metered addition.

The invention further provides a process for producing vulcanizates based on the inventive hydrogenated nitrile rubbers, characterized in that the vulcanizable mixtures comprising the inventive hydrogenated nitrile rubber are subjected to vulcanization. Typically, the vulcanization is effected at temperatures in the range from 100° C. to 200° C., preferably at temperatures of 120° C. to 190° C. and most preferably of 130° C. to 180° C.

The vulcanization is preferably effected in a shaping process.

For this purpose, the vulcanizable mixture is processed further by means of extruders, injection moulding systems, rollers or calenders. The preformed mass thus obtainable is typically then vulcanized to completion in presses, autoclaves, hot air systems, or in what are called automatic mat vulcanization systems, and useful temperatures have been found to be in the range from 120° C. to 200° C., preferably 140° C. to 190° C. The vulcanization time is typically 1 minute to 24 hours and preferably 2 minutes to 1 hour. Depending on the shape and size of the vulcanizates, a further vulcanization may be necessary to achieve complete vulcanization.

The invention accordingly provides the vulcanizates thus obtainable based on the inventive hydrogenated nitrile rubbers. These vulcanizates may take the form of drive belts, of roller coverings, of a seal, of a cap, of a stopper, of a hose, of floor covering, of sealing mats or sheets, profiles or membranes. Specifically, the vulcanizate may be an O-ring seal, a flat seal, a shaft sealing ring, a gasket sleeve, a sealing cap, a dust protection cap, a connector seal, a thermal insulation hose (with or without added PVC), an oil cooler hose, an air suction hose, a power steering hose, a shoe sole or pans thereof, or a pump membrane.

### EXAMPLES

### I Analytical Determination Methods

The quantitative determination of 2,6-di-tert-buty-p-cresol (Vulkanox® KB) in the nirile rubber or in the hydrogenated nitrile rubber is effected by gas chromatography using an internal standard (naphthalene). For the determination, 3 to 5 g of polymer with an accuracy of 0.01 g are dissolved in 40 ml of a toluene/THF mixture (volume ratio 1:1) with stirring in a sealable Erlenmeyer flask. 20.0 mg of naphthalene (dissolved in 5 ml of toluene) are added to the solution as an internal standard and distributed homogeneously by stirring. The polymer is precipitated by adding 80 ml of methanol. The serum is analysed by gas chromatography (Agilent Technologies in Waldbronn, Germany, instrument: 6890) with the following instrument settings:

Capillary column: HP-5, length: 30 m; internal diameter 0.32 mm; film thickness: 0.25 μm
Injection volume: 1 μl
Injection temperature: 320° C.
Oven temperature programme: 100° C., heating rate: 10° C./min>300° C.
Detector temperature: 300° C.

Under these conditions, a retention time of 3.4 min is found for 2,6-di-tert-butyl-p-cresol, and a retention time of 6.44 min for naphthalene.

In independent measurements, under the same conditions, the response ratio of 2,6-di-tert-butyl-p-cresol relative to naphthalene is determined as the basis for the calculation of the content of 2,6-di-tert-butyl-p-cresol.

The quantitative determination of 2,2-methylenebis(4-methyl-6-tert-butylphenol) (Vulkanox® BKF) in nitrile rubber is effected by gas chromatography using an internal standard (n-docosane). For the determination, 3 to 5 g of polymer with an accuracy of 0.01 g are dissolved in 40 ml of a toluene/THF mixture (volume ratio 1:1) with stirring in a sealable Erlenmeyer flask. 50.0 mg of n-docosane (dissolved in 5 ml of toluene) are added to the solution as an internal standard and distributed homogeneously by stirring. The polymer is precipitated by adding 80 ml of methanol. The serum is analysed by gas chromatography (Agilent Technologies in Waldbronn, Germany, instrument: 6890) with the following instrument settings:

Capillary column: HP-5, length: 30 m; internal diameter 0.32 mm; film thickness: 0.25 μm
Injection volume: 1 μl
Injection temperature: 320° C.
Oven temperature programme: 240° C., 10 min., heating rate: 20° C./min>300° C.
Detector temperature: 300° C.

Under these conditions, a retention time of 5.96 min is found for 2,2-methylenebis(4-methyl-6-tert-butylphenol), and a retention time of 3.70 min for n-docosane.

In independent measurements, under the same conditions, the response ratio of 2,2-methylenebis(4-methyl-6-tert-butylphenol) relative to n-docosane is determined as the basis for the calculation of the content of 2,2-methylenebis(4-methyl-6-tert-butylphenol).

The triphenylphosphine content in the hydrogenated nitrile rubber was determined by means of gas chromatography using an internal standard. For the determination, 2 to 3 g±0.01 g of hydrogenated nitrile rubber in each case were weighed into a small test tube and dissolved with 25 ml of acetone, a known amount of an internal standard (docosane from Sigma-Aldrich; CA: 629-97-0) was added and, after mixing thoroughly, precipitation was effected by adding 50 ml of methanol. The precipitation serum was separated by means of gas chromatography using a capillary column (e.g.: HP-5, 0.25 μm film, 30 m×0.32 mm ID).

Injection volume: 1 μl
Injection temperature: 300° C.
Oven temperature programme: 150° C.; 10 min>300° C., 5 min
Detector temperature: 300° C.

For detection, a flame ionization detector (FID) was used.

Under the given conditions, triphenylphosphine and the internal standard have the following retention times:

### Triphenylphosphine: 8.47 min

### Docosane: 8.65 min

For quantitative determination of the amounts of triphenylphosphine (TPP) present in the hydrogenated nitrile rubber, the response factor for TPP/n-docosane was used, which was determined in an independent measurement.

The volatile fractions were determined to ISO 248, 4th edition, in the version of 15 Jun. 2005.

### II NBR Production

### II.1 Emulsion Polymerization

On the basis of the formulation specified in Table 1 below, an NBR latex was produced. All the feedstocks are specified in parts by weight based on 100 parts by weight of the monomer mixture. The polymerization was effected at a temperature of 20° C. for a period of 7 hours until a polymerization conversion of 74% was attained.

TABLE 1
Feedstocks for the production of the nitrile rubber

| Latex production | Parts by wt. |
|---|---|
| butadiene | 56 |
| acrylonitrile | 44 |
| Total amount of water | 200 |
| Erkantol ® BXG¹⁾ | 2.8 |
| Baykanol ® PQ²⁾ | 0.84 |
| K salt of coconut fatty acid | 0.56 |
| KOH | 0.05 |
| t-DDM⁶⁾ | 0.33/0.33 |
| potassium peroxodisulphate³⁾ | 0.27 |
| tris(α-hydroxyethyl)amine ⁴⁾ | 0.15 |
| Na dithionite ⁵⁾ | 1.19 |
| diethylhydroxylamine | 0.5 |
| potassium hydroxide | 1.28 |

¹⁾sodium salt of a mixture of mono- and disulphonated naphthalenesulphonic acids with isobutylene oligomer substituents, Erkantol ® BXG)
²⁾sodium salt of methylene bis(naphthalenesulphonate) (Baykanol ® PQ, Lanxess Deutschland GmbH)
³⁾potassium peroxodisulphate (Aldrich catalogue number: 21,622-4)
⁴⁾ tris(α-hydroxyethyl)amine (Aldrich catalogue number: T5,830-0)
⁵⁾ sodium dithionite (Aldrich catalogue number: 15,795-3)
⁶⁾t-DDM (tertiary dodecyl mercaptan): C₁₂ mercaptan mixture from Lanxess Deutschland GmbH

Table 1 gives two numerical values for the t-DDM⁶⁾ used to control the molecular weight, since the total amount was not metered in in a single portion. The first half was initially charged in the reactor before commencement of polymerization; the second half was subsequently metered in at 15% conversion.

The NBR latex was produced batchwise in a 2 m³ stirred autoclave, 350 kg of the monomer mixture and a total amount of water of 700 kg were used in the batch. The autoclave was initially charged with the emulsifiers Erkantol® BXG (9.8 kg), Baykanol® PQ (2.94 kg) and the potassium salt of coconut fatty acid (1.96 kg) in 600 kg of this amount of water together with 180 g of potassium hydroxide, and purged with a nitrogen stream. After the nitrogen purging had ended, the destabilized monomers (196 kg of butadiene and 154 kg of acrylonitrile) and a portion of the t-DDM regulator (1.16 kg) was added to the reactor. Thereafter, the reactor was closed. The remaining amount of water (100 kg) was used for the production of the aqueous solutions of tris(α-hydroxyethyl)amine, potassium peroxodisulphate and the stopper solutions. By addition of aqueous solutions of 950 g of potassium peroxodisulphate (corresponding to the 0.27 part by weight according to Table 1) and 530 g of tris(α-hydroxyethyl)amine (corresponding to the 0.15 part by weight according to Table 1), the polymerization was started at 20° C. and kept at this temperature over the entire duration. The course of the polymerization was monitored by gravimetric determinations of conversion. At a polymerization conversion of 15%, a further 1.16 kg of t-DDM regulator (corresponding to 0.33 part by weight according to Table 1) was metered in. On attainment of 74% conversion (7 h), the polymerization was stopped by adding an aqueous solution of sodium dithionite/N,N-diethylhydroxylamine (DEHA) and potassium hydroxide. Unconverted monomers and other volatile constituents were removed by means of steam distillation.

After the polymerization, the latex had the following properties (Table 2):

TABLE 2
Properties of the NBR latex

| NBR latex | |
|---|---|
| Solids content [% by wt.] | 22.1 |
| pH | 10.6 |
| Acrylonitrile content [% by wt.] | 38.5% |

II.2 Stabilization and Workup of the NBR Latex which is Used Hereinafter for Hydrogenation (See Table 5)

Before the coagulation, 25 kg of each latex were admixed with 4-methyl-2,6-tert-butylphenol (Vulkanox® KB from Lanxess Deutschland GmbH) or with 2,2-methylenebis(4-methyl-6-tert-butylphenol) (Vulkanox® BKF from Lanxess Deutschland GmbH). For this purpose, 50% dispersions of Vulkanox® KB or Vulkanox® BKF in water were used.

The aqueous dispersions of Vulkanox® KB or of Vulkanox® BKF were based on the following formulation, prepared at 95 to 98° C. with the aid of an Ultraturrax:

| | |
|---|---|
| 360 g | deionized water (DW water) |
| 40 g | alkylphenol polyglycol ether (NP ® 10 emulsifier |
| | from Lanxess Deutschland GmbH) |
| 400 g | Vulkanox ® KB or Vulkanox ® BKF from Lanxess |
| | Deutschland GmbH |

The additions of 4-methyl-2,6-tert-butylphenol or of 2,2-methylenebis(4-methyl-6-tert-butylphenol) were based on the solids present in the latex and reported in % by weight.

An overview of the ageing stabilizers used in the various examples and the amount thereof is given by Table 3.

TABLE 3
Ageing stabilizers used for stabilization
of the nitrile rubber and amount thereof

| | | Example | | | | | | | |
|---|---|---|---|---|---|---|---|---|---|
| | | 1 | 2 | 3 | 4 | 5 | 6 | 7 | 8 |
| Vulkanox ® KB | [% by wt.] | — | 0.7 | 0.7 | — | 0.7 | 0.7 | 0.7 | 0.7 |
| Vulkanox ® BKF | [% by wt.] | 0.06 | — | — | 0.18 | — | — | — | |

The latex coagulation of the examples adduced in Table 3 was effected by working up 25 kg of each latex to give solids. For this purpose, a stirrable, open vessel of capacity 100 l was used. This vessel was initially charged with the latex and heated up to 90° C. while stirring, and coagulation was effected by gradual addition of a 20% aqueous sodium chloride solution while stirring. The sodium chloride solution used for latex coagulation was produced with normal service water (not deionized and thus containing calcium ions). For the coagulation, 20% by weight of sodium chloride was used in each case, based on solids.

For the crumb washing, the coagulation vessel was equipped with an inlet and outlet. On the inside of the vessel, two rails were mounted such that it was possible to shut off the outlet by means of a sieve (mesh size 2 mm) before the wash was conducted, such that the coagulated rubber crumbs were not flushed out in the washing operation. In the examples, the latex serum obtained in the latex coagulation was not removed from the coagulation vessel before commencement of washing; in other words, the latex serum was removed by dilution washing. The wash was conducted with normal service water (not deionized and thus containing calcium ions) at a constant water throughput of 200 l/h at 60° C.

After the washing had ended, the rubber crumbs were removed with a screen, and subjected to mechanical dewatering to residual moisture contents of 10 to 15% by weight in a welding screw and to batchwise thermal drying in a vacuum drying cabinet at 70° C. to a residual moisture content of <1.5% by weight.

The contents of ageing stabilizers present in the nitrile rubbers after the drying are summarized in Table 4.

TABLE 4
Content of various phenols in the nitrile rubber

| | | Example | | | | | | | |
|---|---|---|---|---|---|---|---|---|---|
| | | 1 | 2 | 3 | 4 | 5 | 6 | 7 | 8 |
| Vulkanox ® KB | % by wt. | — | 0.69 | 0.7 | — | 0.70 | 0.69 | 0.7 | 0.68 |
| Vulkanox ® BKF | % by wt. | 0.06 | — | — | 0.18 | — | — | — | — |
| Recovery rate of 2,6-di- | % | — | 99 | 100 | — | 97 | 99 | 100 | 97 |
| tert-butyl-p-cresol in NBR | | | | | | | | | |
| Recovery rate of 2,2- | % | 100 | — | — | 100 | — | — | — | — |
| methylenebis(4-methyl- | | | | | | | | | |
| 6-tert-butylphenol) in NBR | | | | | | | | | |

### III Production of Hydrogenated Nitrile Rubbers

### III.1 Hydrogenation of Nitrile Rubbers

The hydrogenations were conducted under the following boundary conditions:

NBR concentration: 11.8% by weight
Hydrogen pressure: 80 bar
Stirrer speed: 600 min⁻¹

### Temperature: 120-130° C.

Tris(triphenylphosphine)rhodium(I) chloride (Evonik Degussa): 0.08% by weight

### Triphenylphosphine (BASF): see Table 5

2,2-Methylenebis(4-methyl-6-tert-butylphenol) see Table 5

In each of the hydrogenations, 4.0 kg of the nitrile rubber produced as described in section II.2 were dissolved in 29.50 kg of chlorobenzene in a 40 l autoclave. Before the hydrogenation, the polymer solution was successively contacted once with nitrogen (20 bar) and twice with hydrogen (20 bar) while stirring, and then decompressed. The reaction mixture was heated to 120° C. and contacted with 80 bar hydrogen. In the next step, the triphenylphosphine cocatalyst, based on nitrile rubber, was metered into the reactor as a solution in 250 g of chlorobenzene, and the triphenylphosphine-containing solution in Inventive Examples 2* and 3* additionally contained Vulkanox® BKF (Table 5). The hydrogenation was started by adding tris(triphenylphosphine)rhodium(I) chloride (dissolved in 250 g of chlorobenzene). With declining reaction, the internal temperature was increased gradually to 130° C. The course of the hydrogenation was effected by IR spectroscopy in accordance with the method described in Kautschuk+Gummi. Kunststoff, vol. 42 (1989), no. 3, pages 194-197. The hydrogenations were each stopped by cooling on attainment of a residual double bond content <1% after the reaction times reported in Table 5. Subsequently, the batches were decompressed. Residual amounts of hydrogen were removed by passing nitrogen through.

TABLE 5
Influence of triphenylphosphine and Vulkanox ® BKF additions on the dependence of
the residual double bond content on the hydrogenation time (inventive examples each indicated by “*”)

| | | Example | | | | | | | |
|---|---|---|---|---|---|---|---|---|---|
| | | 1* | 2* | 3* | 4* | 5 | 6 | 7 | 8 |
| Vulkanox ® KB | % by wt. | — | 0.69 | 0.70 | — | 0.70 | 0.69 | 0.70 | 0.68 |
| in NBR | | | | | | | | | |
| Vulkanox ® BKF | % by wt. | 0.06 | — | — | 0.18 | — | — | — | — |
| in NBR | | | | | | | | | |
| Triphenylphosphine | % by wt. | 0.8 | 0.8 | 1.0 | 1.0 | 0.8 | 1.0 | 2.5 | 3.0 |
| BKF addition to | % by wt. | — | 0.1 | 0.12 | — | — | — | — | — |
| hydrogenation | | | | | | | | | |
| Hydrogenation time | h | Residual double bond contents [%] | | | | | | | |
| 0 | h | 100 | 100 | 100 | 100 | 100 | 100 | 100 | 100 |
| 0.5 | h | 74 | 70 | 62 | 60 | 80 | 76 | 69 | 64 |
| 1.0 | h | 55 | 50 | 46 | 41 | 65 | 57 | 48 | 42 |
| 1.5 | h | 42 | 35 | 31 | 27 | 50 | 44 | 33 | 28 |
| 2 | h | 32 | 25 | 21 | 18 | 40 | 34 | 22 | 20 |
| 3 | h | 17 | 14 | 11 | 9 | 25 | 20 | 12 | 9.5 |
| 4 | h | 9 | 7 | 5.5 | 4.2 | 15 | 12 | 6.3 | 4.8 |
| 5 | h | 5.3 | 4.5 | 2.8 | 2.3 | 10 | 7 | 3.6 | 2.5 |
| 6 | h | 3.3 | 2.7 | 1.6 | 1.2 | 6.5 | 4.5 | 2.1 | 1.4 |
| 7 | h | 2.1 | 1.6 | 0.9 | 0.65 | 4.5 | 3 | 1.3 | 0.8 |
| 8 | h | 1.5 | 1.1 | — | — | 3.2 | 2.1 | 0.8 | — |
| 9 | h | 1.1 | 0.75 | — | — | 2.3 | 1.5 | — | — |
| 10 | h | 0.85 | — | — | — | 1.8 | 1.1 | — | — |
| 11 | h | — | — | — | — | 1.3 | 0.9 | — | — |
| 12 | h | — | — | — | — | 1.0 | — | — | — |
| 13 | h | — | — | — | — | 0.8 | — | — | — |

It becomes clear in Table 5 that increasing the amount of triphenylphosphine from 0.8 to 3.0 phr increases the hydrogenation rate (Noninventive Examples 5 to 8). Through comparison of Inventive Examples 1* and 2* with Example 5 and by comparison of Inventive Examples 3* and 4* with Example 6, it becomes clear that the inventive additions of 2,2-methylenebis(4-methyl-6-tert-butylphenol) (Vulkanox® BKF from Lanxess Deutschland GmbH), irrespective of the amount of triphenylphosphine used in the hydrogenation (0.8 or 1.0% by weight), bring about a considerable acceleration in the hydrogenation rate. It is unimportant whether 2,2-methylenebis(4-methyl-6-tert-butylphenol) is added to the hydrogenation batch together with the nitrile rubber (Inventive Examples 1* and 4*) or separately (Inventive Examples 2* and 3*).

### III.2 Workup of the HNBR Solutions in Chlorobenzene

The isolation of the hydrogenated nitrile rubbers of Examples 1-8 from the hydrogenation described above under III.1 from the chlorobenzene solution was effected in semicontinuous mode without preceding rhodium removal by steam distillation. For the steam distillation, a stirrable 20 l glass flange vessel with jacket heating was used. Steam was fed in via a base valve. In addition, the stripping vessel had devices for continuous metered addition of an HNBR solution in chlorobenzene, of a 2% aqueous solution of a water-soluble polymer containing carboxyl groups (Orotan®, from Rohm and Haas), of a 2% aqueous calcium chloride solution and of dilute sodium hydroxide solution (0.5%).

The stripping vessel was initially charged with 8.5 l of deionized water and heated to 98-100° C. by jacket heating. After commencement of the introduction of steam, the separate metered addition of the chlorobenzene solution, heated to 95-100° C., of the hydrogenated nitrile rubber (0.5 kg of HNBR/h) and of the aqueous solution of Orotan® and calcium chloride was commenced at a stirrer speed of 2000 rpm. The rates of metered addition of Orotan® and calcium chloride were adjusted such that 0.3 part by weight of Orotan® and 0.15 part by weight of calcium chloride, based in each case on 100 parts by weight of the amount of hydrogenated nitrile rubber present in the stripping vessel, were present at any time. In addition, the pH of the aqueous phase was kept within a pH range from 7.7 to 8.3 over the entire stripping process by addition of dilute sodium hydroxide solution (0.5%). The vapours consisting of chlorobenzene and steam were distilled off at atmospheric pressure at 98-100° C. and condensed. The metered addition of HNBR solution was ended as soon as 1.5 kg of HNBR were present in the stripping vessel. Thereafter, the steam distillation was continued for another 0.5 h. After the steam distillation had ended, the hydrogenated nitrile rubber was present in the aqueous dispersion in the form of rubber crumbs in the diameter range of 3 to 10 mm. After the flange vessel had been opened, the rubber crumbs were removed by means of a screen. The remaining water was removed mechanically by drip-drying and squeezing. The residual moisture were between 15-20% by weight.

The subsequent drying of the water-moist HNBR crumbs was effected in a fluidized bed dryer (TG 200 high-speed dryer from Kurt Retsch (Haan/Düsseldorf) having a capacity of 6 l, 0.5 kg of the moist hydrogenated nitrile rubber in each case was dried at 120-130° C. for 5 minutes. The flow rate of the hot air in all the experiments was kept constant at 100 m³/h. The contents of 2,6-di-tert-butyl-p-cresol and 2,2-methylenebis(4-methyl-6-tert-butylphenol) were determined in the dried hydrogenated nitrile rubber (Table 6).

TABLE 6
Properties of the unvulcanized hydrogenated nitrile rubbers
(inventive products indicated by “*”)

| | | Example | | | | | | | |
|---|---|---|---|---|---|---|---|---|---|
| | | 1* | 2* | 3* | 4* | 5 | 6 | 7 | 8 |
| triphenylphosphine | % by wt. | 0.52 | 0.52 | 0.73 | 0.72 | 0.53 | 0.72 | 2.1 | 2.6 |
| 2,6-di-tert-butyl-p-cresol | % by wt. | — | 0.37 | 0.34 | — | 0.52 | 0.46 | 0.35 | 0.37 |
| in HNBR | | | | | | | | | |
| 2,2-methylenebis(4-methyl- | % by wt. | 0.06 | 0.10 | 0.12 | 0.18 | — | — | — | — |
| 6-tert-butylphenol) in HNBR | | | | | | | | | |

Table 6 shows that the hydrogenated nitrile rubbers produced in accordance with the invention contain triphenylphosphine in amounts of 0.52 to 0.73% by weight and methylenebis(4-methyl-6-tert-butylphenol) in amounts of 0.06 to 0.18% by weight (Examples 1* to 4*). The noninventive hydrogenated nitrile rubbers 5 to 8 contain triphenylphosphine in amounts of 0.53 to 2.6% by weight and no methylenebis(4-methyl-6-tert-butylphenol).

To determine the vulcanizate properties, rubber mixtures were produced from the hydrogenated nitrile rubbers of Table 6 and vulcanized, and the vulcanization characteristics and properties were determined. For the production of the rubber mixtures, the mixture listed in Table 7 was used.

TABLE 7
Composition of the rubber mixtures

| | | Amounts |
|---|---|---|
| | | [parts by |
| Mixture constituents | | weight] |
| Hydrogenated nitrile rubber | see Table 6 | 100 |
| Carbon black | Corax ® N 550 (Degussa) | 45 |
| Octylated diphenylamine | Rhenofit ® DDA-70 (RheinChemie Rheinau GmbH) | 1.43 |
| Zinc salt of 2- | Vulkanox ® ZMB-2 (Lanxess Deutschland GmbH) | 0.4 |
| mercaptobenzimidazole | | |
| Zinc oxide | Zinkoxid aktiv (Lanxess Deutschland GmbH) | 2.0 |
| Magnesium oxide | Maglite ® DE (Merck & Co. Inc. USA) | 2.0 |
| Triallyl isocyanurate | Kettlitz ® TAIC 50 | 1.5 |
| Bis(tert-butylperoxyiso- | Perkadox ® 14-40 B-PD (Akzo- | 7.0 |
| propyl)benzene (40%) | Nobel Chemicals GmbH) | |

The rubber mixtures having the components listed in Table 7 were produced in an internal mixer (capacity 1.5 l) having “intermeshing rotor geometry” (GK1.5E from Werner & Pfleiderer). In the production of the mixture, the rotor speed (40 rpm) and the ram pressure (8 bar) were kept constant. In the first step, the hydrogenated nitrile rubber was added to the mixer. After 30 s, the other mixture constituents were added in the sequence specified in Table 7 (apart from the peroxide). After a mixing time of 4 min, the mixture was ejected. The peroxide was mixed in shortly before vulcanization on a cooled roller at a temperature of <50° C.

### IV. Properties of the Unvulcanized Rubber Mixtures

To assess the processing characteristics of the unvulcanized rubber mixtures, the Mooney viscosity (ML 1+4/100° C.) was determined to ASTM D1646.

The vulcanization characteristics of the mixtures were examined to ASTM D 5289 at 180° C. with the aid of a moving die rheometer (MDR2000 from Alpha Technology). In this way, the characteristic vulcameter values, Fₐ, Fₘₐₓ, Fₘₐₓ-Fₐ, t₁₀, t₅₀, t₉₀ and t₉₅, were determined.

According to DIN 53 529, Part 3, the following characteristics have the following meanings:

Fₘᵢₙ: vulcameter value at the minimum of the crosslinking isotherm
Fₘₐₓ: maximum vulcameter value
Fₘₐₓ-Fₐ: difference in the vulcameter values between maximum and minimum
t₁₀: time at which 10% of the final conversion has been attained
t₅₀: time at which 50% of the final conversion has been attained
t₉₀: time at which 90% of the final conversion has been attained
t₉₅: time at which 95% of the final conversion has been attained

The properties determined in the unvulcanized rubber mixtures are summarized in Table 8.

TABLE 8
Properties of the unvulcanized rubber mixtures

| Example | | | | | | | |
|---|---|---|---|---|---|---|---|
| 1* | 2* | 3* | 4* | 5 | 6 | 7 | 8 |

Mixture properties

| | | | | | | | | | |
|---|---|---|---|---|---|---|---|---|---|
| ML1 + 4 at 100° C. | ME | 123.0 | 122.3 | 124.7 | 125.5 | 126.7 | 123.8 | 120.8 | 118.1 |

Vulcameter at 180° C. (moving die rheometer)

| | | | | | | | | | |
|---|---|---|---|---|---|---|---|---|---|
| t₁₀ | sec | 37 | 39 | 39 | 36 | 38 | 37 | 37 | 37 |
| t₅₀ | sec | 106 | 113 | 118 | 105 | 114 | 115 | 114 | 115 |
| t₉₀ | sec | 335 | 331 | 336 | 301 | 322 | 328 | 334 | 336 |
| t₉₅ | sec | 446 | 435 | 434 | 389 | 416 | 425 | 429 | 430 |
| t₉₀ − t₁₀ | sec | 298 | 292 | 297 | 265 | 284 | 291 | 297 | 299 |
| Fₘᵢₙ | dNm | 1.96 | 1.73 | 1.85 | 1.93 | 1.94 | 1.88 | 1.85 | 1.73 |
| Fₘₐₓ | dNm | 26.20 | 23.40 | 22.28 | 25.43 | 25.83 | 24.26 | 19.86 | 18.19 |
| Fₘₐₓ − Fₘₐₓ | dNm | 24.24 | 21.67 | 20.43 | 23.50 | 23.89 | 22.38 | 18.01 | 16.46 |

As is apparent from Table 8, there is no significant difference between the vulcanization rates of the rubber mixtures based on the rubbers produced in accordance with the invention (Examples 1* to 4*) and those of the rubber mixtures based on the noninventive Comparative Examples 4 to 8.

Based on the rubber mixtures, specimens were produced by vulcanization at 180° C./26 min. in a press at a hydraulic pressure of 120 bar and (without heat treatment) cooled to room temperature.

The Vulcanizate Properties were Determined on the Basis of the Following Standards:
DIN 53505: Shore A hardness at 23° C. and 70° C. (“Shore A/23° C.” and “Shore A/70° C.”)
DIN 53512: Resilience at 23° C. and 70° C. (“R23” and “R70”)
DIN 53504: Stress values at 10%, 25%, 50%, 100%, 200% and 300% elongation (σ₁₀, σ₂₅, σ₅₀, σ₁₀₀, σ₂₀₀ and σ₃₀₀), tensile strength and elongation at break
DIN 53516: Abrasion
DIN 53517 Compression set (CS); determination on cylindrical specimens 1 (height: 6.3; diameter: 13 mm)
   after storage at 70 h/23° C.: CS (70 h/023° C.)
   after storage at 70 h/150° C. CS (70 h/150° C.).

The vulcanizate properties of the rubber mixtures are compiled in Table 9.

TABLE 9
Vulcanizate properties (inventive examples indicated by “*”)

| | | Example | | | | | | | |
|---|---|---|---|---|---|---|---|---|---|
| | | 1* | 2* | 3* | 4* | 5 | 6 | 7 | 8 |
| Shore A hardness | | 69.1 | 68.5 | 68.9 | 68.9 | 69.1 | 68.9 | 68.4 | 67.5 |
| (23° C.) | | | | | | | | | |
| Shore A hardness | | 63.2 | 61.5 | 62.0 | 64.0 | 62.1 | 61.8 | 59.7 | 59.8 |
| (70° C.) | | | | | | | | | |
| R23 | % | 38.9 | 39.6 | 39.8 | 39.1 | 39.4 | 40.1 | 39.7 | 39.4 |
| R70 | % | 59.1 | 58.2 | 57.2 | 57.9 | 58.0 | 58.8 | 57.0 | 54.9 |
| S₅₀ | MPa | 2.3 | 2.0 | 2.0 | 2.2 | 2.0 | 1.9 | 2.0 | 1.9 |
| S₁₀₀ | MPa | 5.8 | 4.9 | 4.9 | 5.6 | 4.8 | 4.3 | 4.1 | 4.0 |
| S₂₀₀ | MPa | 17.4 | 14.8 | 15.1 | 16.8 | 14.1 | 13.9 | 12.4 | 12.0 |
| S₃₀₀ | MPa | 25.5 | 23.5 | 23.7 | 24.7 | 22.9 | 22.5 | 20.1 | 18.7 |
| Tensile strength | MPa | 27.6 | 27.0 | 27.1 | 27.8 | 26.8 | 28.0 | 26.2 | 25.1 |
| ε_{b} | % | 335 | 375 | 372 | 368 | 385 | 410 | 429 | 488 |
| CS (70 h/023° C.) | % | 14.0 | 16.2 | 16.2 | 15.4 | 16.4 | 18.6 | 20.2 | 22.0 |
| CS (70 h/150° C.) | % | 34.8 | 39.7 | 40.7 | 35.7 | 40.9 | 41.7 | 45.4 | 49.7 |
| Abrasion | mm³ | 45 | 48 | 48 | 46 | 48 | 50 | 53 | 53 |

Table 9 shows that the vulcanizates based on the hydrogenated nitrile rubbers produced in accordance with the invention (Examples 1*, 2*, 3* and 4*) have a higher modulus level and a lower compression set (both after storage at 70 h/23° C. and after 70 W/150° C.) than the vulcanizates based on the rubbers 5, 6, 7 and 8 not produced in accordance with the invention. A particularly favourable level of modulus and compression set is found in the vulcanizates based on the hydrogenated nitrile rubbers 1* and 4*, in which the NBR feedstock contains, as ageing stabilizer, 2,6-di-tert-butyl-p-cresol (and no 2,2-methylenebis(4-methyl-6-tert-butylphenol).

1. Hydrogenated nitrile rubber comprising 0.01 to 0.25% by weight, based on the hydrogenated nitrile rubber, of at least one substituted phenol of the general formula (I) 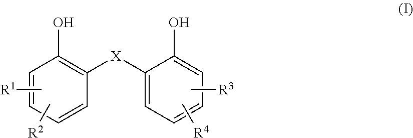
in which
X is sulphur, a divalent, straight-chain or branched, acyclic or cyclic hydrocarbyl group, or a radical of the formula (II) in which n=0 to 9 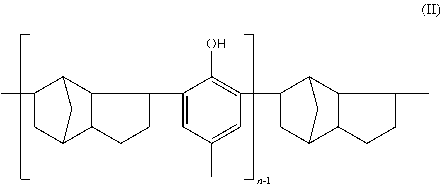
R¹, R², R³ and R⁴ are the same or different and are each straight-chain or branched, unsubstituted or substituted C₁-C₈ alkyl groups.

2. The hydrogenated nitrile rubber according to claim 1, wherein the phenol of the general formula (I) is selected from the group consisting of 2,2-methylenebis(4-methyl-6-tert-butylphenol), 2,2-thiobis(6-tert-butyl-p-cresol), and a butylated reaction product of p-cresol and dicyclopentadiene of the following formula:

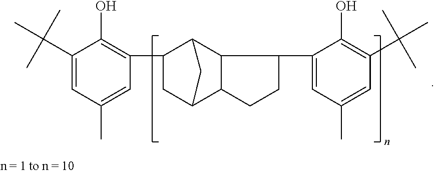

3. The hydrogenated nitrile rubber according to claim 1, wherein the nitrile rubber comprises repeating units derived from at least acrylonitrile and 1,3-butadiene.

4. The hydrogenated nitrile rubber according to claim 1, wherein the nitrile rubber contains 0.01 to 0.19 wt % of the phenol of general formula (I), based on the hydrogenated nitrite rubber.

5. The hydrogenated nitrile rubber according to claim 4, wherein the nitrile rubber contains 0.01 to 0.18% of the phenol of general formula (I).

6. The hydrogenated nitrile rubber according to claim 1, wherein the nitrile rubber possesses a hydrogenation degree of 95 to 100%, and contains 0.01 to 0.19 wt % of the at least one phenol of general formula (I) based on the hydrogenated nitrile rubber.

7. The hydrogenated nitrile rubber according to claim 1, wherein the nitrile rubber has exclusively repeating units derived from acrylonitrile and butadiene, and contains 0.01 to 0.19 wt % of the at least one phenol of general formula (I), based on the hydrogenated nitrile rubber.

8. A process for producing the hydrogenated nitrile rubbers according to claim 1, the process comprising hydrogenation of nitrile rubbers in solution in the presence of at least one phenol of the general formula (I) 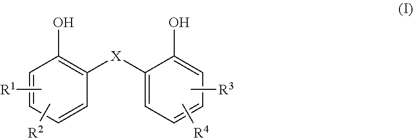
in which
X is sulphur, a divalent, straight-chain or branched, acyclic or cyclic hydrocarbyl group, or a radical of the formula (II) in which n=0 to 9 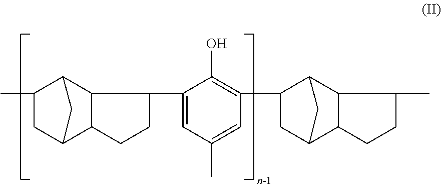
R¹, R², R³ and R⁴ are the same or different and are each straight-chain or branched, unsubstituted or substituted C₁-C₈ alkyl groups.

9. The process for producing hydrogenated nitrile rubbers according to claim 8, wherein a nitrile rubber containing at least one phenol of the general formula (I) in an amount of 0.01 to 0.25% by weight, based on the nitrile rubber, is used.

10. The process for producing hydrogenated nitrile rubbers according to claim 8, further comprising introducing 0.01 to 0.25% by weight of the phenol of the general formula (I) into the hydrogenation mixture based on the nitrile rubber used.

11. The process for producing hydrogenated nitrile rubbers according to claim 8, wherein the hydrogenation is done in the presence of 0 to 1 wt % triphenylphosphine, based on the nitrile rubber used.

12. The process for producing hydrogenated nitrile rubbers according to claim 8, further comprising, after the hydrogenation, removing the solvent, and isolating and dewatering the hydrogenated nitrile rubber.

13. Vulcanizable mixtures comprising at least one hydrogenated nitrile rubber according to claim 1 and at least one crosslinking system comprising at least one crosslinker and optionally one or more crosslinking accelerators.

14. A process for producing vulcanizates in the form of shaped bodies, the process comprising vulcanizing the vulcanizable mixture according to claim 13 at a temperature of 100° C. to 200° C.

15. Vulcanizates obtained by the process according to claim 14.

16. The vulcanizates according to claim 15, wherein the vulcanizates are in the form of drive belts, of roller coverings, of a seal, of a cap, of a stopper, of a hose, of floor covering, of sealing mats or sheets, profiles or membranes.

17. The vulcanizates according to claim 16, wherein the vulcanizates are in the form of an O-ring seal, a flat seal, a shaft sealing ring, a gasket sleeve, a sealing cap, a dust protection cap, a connector seal, a thermal insulation hose (with or without added PVC), an oil cooler hose, an air suction hose, a power steering hose, a shoe sole or parts thereof, or a pump membrane.

18. The hydrogenated nitrile rubber according to claim 1, wherein:
the nitrile rubber comprises 0.05 to 0.18% by weight, based on the hydrogenated nitrile rubber, of at least one substituted phenol of the general formula (I) 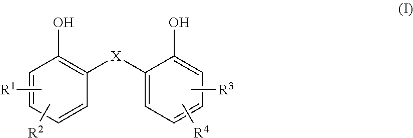
in which
X is sulphur, methylene, ethylene or n-propylene, or a radical of the formula (II) in which n=0 to 9 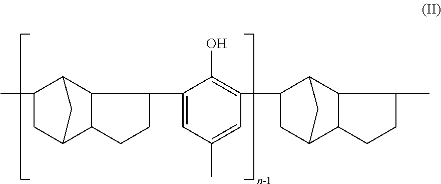
R¹, R², R³ and R⁴ are the same or different and are each straight-chain or branched, unsubstituted or substituted C₁-C₆ alkyl groups; and
the nitrile rubber comprises repeating units derived from acrylonitrile and 1,3-butadiene, or from acrylonitrile, 1,3-butadiene, and one or more α,β-unsaturated mono- or dicarboxylic acid(s), or esters or amides thereof.

19. The hydrogenated nitrile rubber according to claim 1, wherein:
the nitrile rubber comprises 0.05 to 0.18% by weight, based on the hydrogenated nitrile rubber, of the phenol of the general formula (I);
the phenol of the general formula (I) s selected from the group consisting of 2,2-methylenebis(4-methyl-6-tert-butylphenol), 2,2-thiobis(6-tert-butyl-p-cresol), and a butylated reaction product of p-cresol and dicyclopentadiene of the following formula: 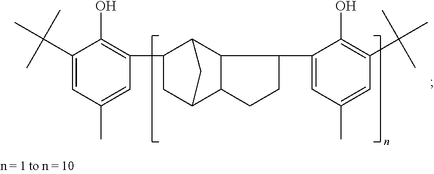
and
the nitrile rubber comprises repeating units derived from acrylonitrile and 1,3-butadiene, or from acrylonitrile, 1,3-butadiene, and one or more α,β-unsaturated mono- or dicarboxylic acid(s), or esters or amides thereof.

20. The hydrogenated nitrile rubber according to claim 19, wherein:
the nitrile rubber comprises repeating units derived only from acrylonitrile and 1,3-butadiene; and
the nitrile rubber is a fully hydrogenated nitrile rubber with a hydrogenation degree greater than or equal to 99.1%.
